(19) United States
(12) Patent Application Publication
(10) Pub. No.: US 2026/0173090 A1
(43) Pub. Date: Jun. 18, 2026

(54) TRANSMISSION OF A BASE LAYER AND AN ENHANCEMENT LAYER OF A DATA STREAM WITH DIFFERENT MODULATION PARAMETERS USING INDICATED UPLINK RESOURCES

(71) Applicant: InterDigital Patent Holdings, Inc., Wilmington, DE (US)

(72) Inventors: Salah Elhoushy, LaSalle (CA); Umer Salim, Vallauris (FR); Pascal Adjakple, Great Neck, NY (US); Ravikumar Pragada, Warrington, PA (US); Milind Kulkarni, Hawthorn Woods, IL (US)

(73) Assignee: InterDigital Patent Holdings, Inc., Wilmington, DE (US)

(21) Appl. No.: 19/126,031

(22) PCT Filed: Nov. 7, 2023
(86) PCT No.: PCT/US2023/036908

§ 371 Date: Apr. 30, 2025

Related U.S. Application Data
(60) Provisional application No. 63/423,317, filed on Nov. 7, 2022.

(51) Int. Cl. H04W 72/23; H04L 1/00; H04L 65/612; H04L 65/70

(52) U.S. Cl. CPC H04W 72/23; H04L 1/0026; H04L 65/612; H04L 65/70

(57) ABSTRACT

Described herein are systems, methods, and instrumentalities associated with constellation schemes. A wireless transmit/receive unit (WTRU) may receive a message from a network device, wherein the message may indicate at least an uplink grant, a first set of modulation parameters, and a second set of modulation parameters. The WTRU may determine that a first media data unit and a second media data unit are to be transmitted to the network device. If the first media data unit differs from the second media data unit with respect to at least a transmission priority, the WTRU may modulate the first media data unit using the first set of modulation parameters, modulate the second media data unit using the second set of modulation parameters, and transmit the first modulated media data unit and the second modulated media data unit to the network device using respective subsets of the uplink grant.

### CROSS-REFERENCE TO RELATED APPLICATIONS

This application claims the benefit of Provisional U.S. Patent Application No. 63/423,317, filed Nov. 7, 2022, the disclosure of which is incorporated herein by reference in its entirety.

### BACKGROUND

Mobile media services, cloud augmented reality (AR) and/or virtual reality (VR), cloud gaming, and/or video-based tele-control for machines or drones may contribute more and more traffic to a wireless communication system. Such media traffic may share common characteristics, for example, regardless of which codec is used to create the media contents. These characteristics may be useful for improving transmission control and/or efficiency, for example, if they are known to the network (e.g., a radio access network (RAN). Current communication systems may use common quality of service (QoS) mechanisms to handle media services together with other data services without taking advantage of the characteristic information.

### SUMMARY

Described herein are systems, methods, and instrumentalities associated with constellation schemes. A wireless transmit/receive unit (WTRU) as described herein may receive a message from a network device, wherein the message may indicate at least an uplink grant, a first set of modulation parameters, and a second set of modulation parameters. The WTRU may determine that a first media data unit and a second media data unit are to be transmitted to the network device. If the first media data unit differs from the second media data unit with respect to at least a transmission priority, the WTRU may modulate the first media data unit using the first set of modulation parameters, modulate the second media data unit using the second set of modulation parameters, and transmit the first modulated media data unit and the second modulated media data unit to the network device. The WTRU may transmit the first modulated media data unit using a first subset of the uplink grant and transmit the second modulated media data unit using a second subset of the uplink grant.

In examples, the first media data unit may include a base layer of video data, wherein the second media data unit may include an enhancement layer of video data, and wherein the base layer may be associated with a high transmission priority than the enhancement layer. In examples, the base layer and the enhancement layer may be associated with the same video content and, when processed together with the base layer, the enhancement layer may improve the quality of the video content.

In examples, the WTRU may determine a target set of modulation parameters associated with the base layer of video data or the enhancement layer of video data, and transmit a report indicative of the target set of modulation parameters to the network device. In these examples, the message that indicates the uplink grant, the first set of modulation parameters, and the second set of modulation parameters may be received from the network device in response to the transmission of the report.

In examples, the first set of modulation parameters may include one or more of a first modulation order or a first coding rate, and the second set of modulation parameters may include one or more of a second modulation order or a second coding rate. In examples, the WTRU may map the first set of modulation parameters to the first media data unit and the second set of modulation parameters to the second media data unit automatically, while in other examples the message received from the network device may indicate that the first set of modulation parameters is to be used for the first media data unit and that the second set of modulation parameters is to be used for the second media data unit.

In examples, the WTRU may determine the first subset of the uplink grant to be used to transmit the first media unit and the second subset of the uplink grant to be used to transmit the first media unit. The WTRU may multiplex the first modulated media data unit and the second modulated media data unit, and transmit the multiplexed data using the determined resources.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a diagram illustrating an example of a multi-modal interactive system.

FIG. 3 is a diagram illustrating examples of group of pictures (GoP) frame viewing and a transmission order.

FIG. 4 is a diagram illustrating example effects of an error in a video frame.

FIG. 5 is a diagram illustrating an example of an architecture for a layered video scheme.

FIG. 6 is a diagram illustrating an example of dependency between video partitions.

FIG. 7 is a diagram illustrating an example of dependency between video layers.

FIG. 8 is a diagram illustrating an example of dependency in a stereoscopic video stream.

FIG. 9 is a diagram illustrating an example of a video stream packetized into a RTP PDU stream.

FIG. 10 is a diagram illustrating an example of a QoS model with an extension for media PDU classification.

FIG. 11 is a diagram illustrating examples of PDU sets.

FIG. 12 is a diagram illustrating examples of control plane protocol stack layers.

FIG. 13 is a diagram illustrating examples of user plane protocol stack layers.

FIG. 14 is a diagram illustrating an example of video layer-aware scheduling.

FIG. 15 is a diagram illustrating examples of separate constellation-based operations.

FIG. 16 is a diagram illustrating examples of WTRU actions associated with enabling a separate constellation based UEP framework for DL transmissions.

FIG. 17 is a diagram illustrating examples of WTRU actions associated with enabling a separate constellation based UEP framework for UL transmissions.

FIG. 18 is a diagram illustrating an example of allocating different subcarriers for different video layers.

FIG. 19 is a diagram illustrating an example of frequency allocation for different video layers for frequency allocation type 0.

FIG. 20 is a diagram illustrating examples of WTRU actions associated with identifying allocated RBs for different video layers under frequency allocation type 0.

FIG. 21 is a diagram illustrating an example of frequency allocation for different video layers under frequency allocation type 1.

FIG. 22 is a diagram illustrating examples of WTRU actions associated with identifying allocated RBs for different video layers under frequency allocation type 1.

FIG. 23 is a diagram illustrating examples of WTRU actions associated with identifying allocated time resources for a video layer.

FIG. 24 is a diagram illustrating an example of separate-constellation UEP in the DL.

FIG. 25 is a diagram illustrating an example of separate-constellation UEP in the UL.

FIG. 26 is a diagram illustrating an example of separate-constellation UEP in the UL with feedback.

FIG. 27 is a diagram illustrating example of operations and messages that may be associated with differentiated modulations and/or resource allocations for media data units (e.g., video layers).

### DETAILED DESCRIPITION

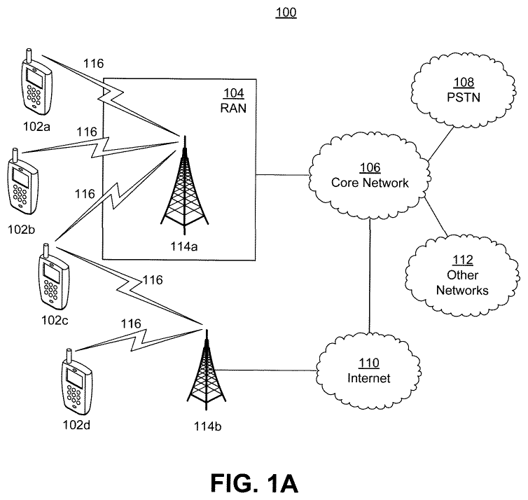

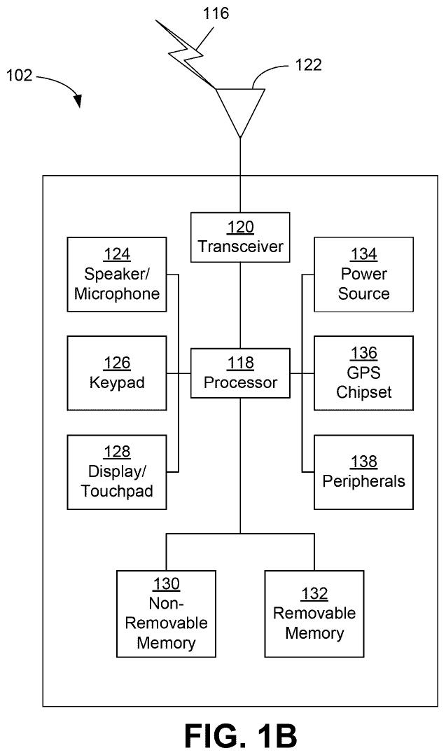

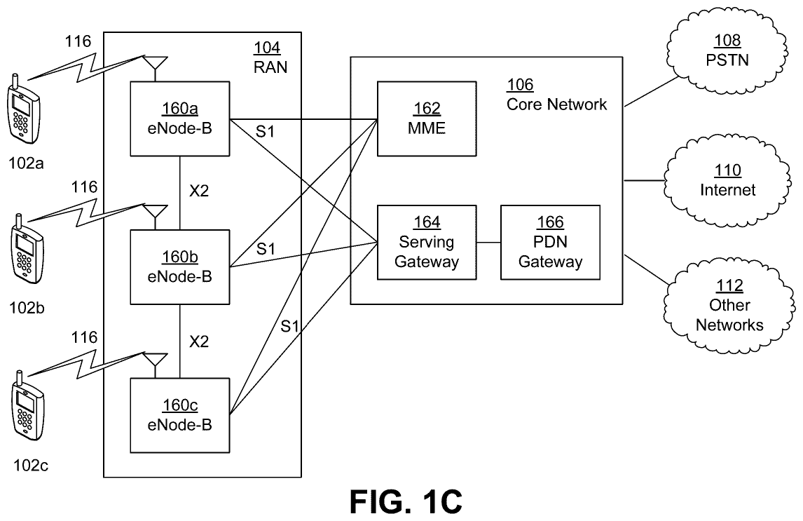

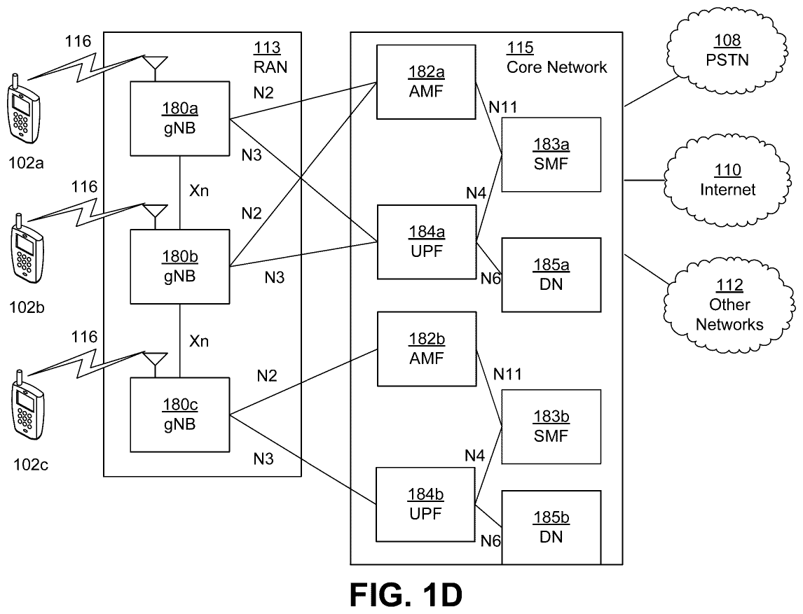

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (WTRU), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c, and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B (eNB), a Home Node B, a Home eNode B, a gNode B (gNB), a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements is depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a distribution system (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may perform testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

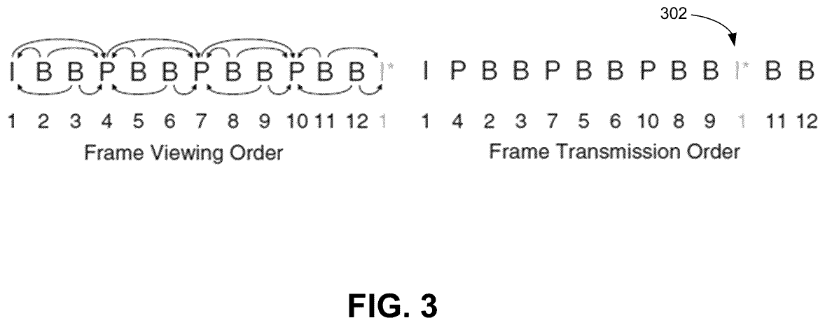

Wireless communication systems such as a fifth generation (5G) system (5GS) may use quality of service (QoS) mechanisms to handle media services together with other data services (e.g., without considering the characteristics of the media services). For example, packets within an application data frame may depend on each other (e.g., since the application may use these packets for decoding the frame). The loss of one packet may make other related packets useless even if they are successfully transmitted. An extended reality (XR) application may impose requirements (e.g., QoS requirements) in terms of media units (e.g., such as application data units) rather than packets or protocol data units (PDUs). Packets of the same video stream may have different frame types (e.g., I, P, or B frames) and/or different positions in a group of pictures (GoP) (e.g., as shown in FIG. 3). These packets may contribute differently to user experience. Layer-based QoS handling within a video stream may relax stringent QoS requirements and lead to higher efficiency.

Enhancements to QoS mechanisms may consider the characteristics of XR and/or other types of media services. A network's exposure to applications may be enhanced, for example, to help applications adapt to network status and/or improve the quality of experience (QoE) (e.g., for media services that may have large traffic bursts). XR and/or other types of media traffic may be characterized by high throughput, low latency, and/or high reliability requirements, and a WTRU's battery level may impact the user's experience (e.g., since the high throughput may be associated with high-power consumption on the WTRU). QoS and/or QoE requirements may become more stringent as wireless communication technologies move towards the next generation. Radio resources may become more limited and end-to-end QoS policy control may be performed from the system perspective. System optimizations and enhancements in support of a trade-off among throughput, latency, reliability, and device battery life may be implemented.

XR or other types of media services may include more modalities besides video and audio streams. These additional modalities may include, for example, information from different sensors and tactile or emotion data for more immersive user experience (e.g., based on haptic data or sensor data). To support such tactile and multi-modality services, different types of traffic streams with coordinated QoS selection and packet processing may be allowed, along with guaranteed latency and reliability, time synchronization of parallel information, etc., to ensure satisfactory service experience.

Multi-modality communication services may involve multi-modal data, which may include input data from different kinds of devices or sensors, or output data to different kinds of destinations (e.g., one or more WTRUs) that may be involved in a same task or application. Multi-modal data may include multiple single-modal data, and there be may dependency between the single-modal data. The single-modal data may be deemed as a type of data herein.

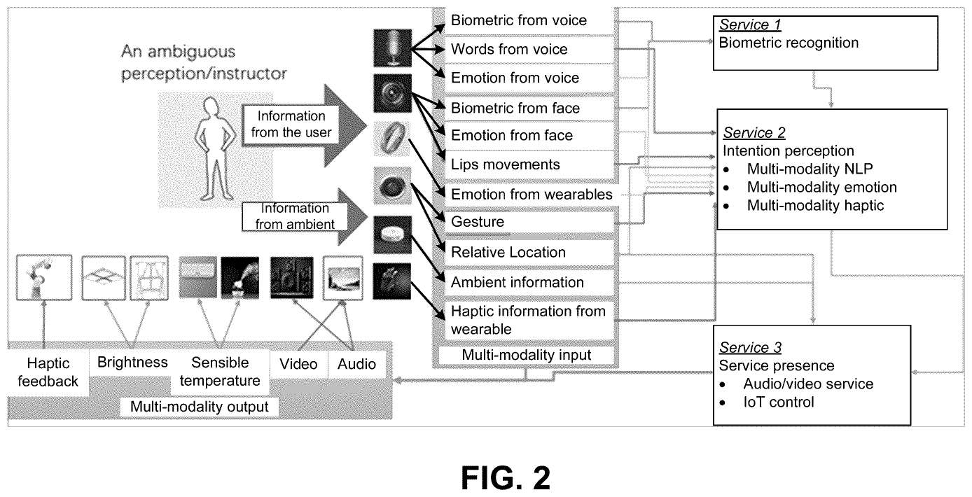

FIG. 2 illustrates an example of a multi-modal interactive system. As shown in this figure, multi-modal outputs may be generated based on inputs from multiple sources. In the example multi-modal interactive system, modality may correspond to a type or a representation of information in a specific interactive system. Multi-modal interaction may include a process in which information of multiple modalities may be exchanged. The types of multi-modal data may include motion, sentiment, gesture, etc. The modal representations may include video, audio, tactile sensations or movements (e.g., vibrations or other movements that may provide haptic or tactile sensations to a person or a machine), etc. Examples of multi-modality communication services may include immersive multi-modal virtual reality (VR) applications, remote control robots, immersive VR games, skillset sharing for cooperative perception and maneuvering of robots, liven vent selective immersion, haptic feedback for a person exclusion zone in a dangerous remote environment, etc.

In the examples provided herein, video data may be used as a simplified example of multi-modality data, but those skilled in the art will appreciate that the techniques disclosed herein are not limited to video data and may be applicable to other types of data as well.

A video traffic stream (denoted herein for simplicity as a video stream) may be a structure that includes a group of pictures (GoP), where a (e.g., each) picture may constitute a video frame, as illustrated by FIG. 3. The frames may be of different types and the different frame types may serve varying purposes (e.g., with respect to video application rendering). For example, an “I” frame may be a frame that is compressed based on the information contained in the frame (e.g., there may not be a reference to other video frames before or after the frame itself). “I” may indicate that the frame is “intra” coded. A “P” frame may be a frame that has been compressed using data contained in the frame itself and data from one or more preceding frames (e.g., such as the closest preceding I or P frame). “P” may indicate that the frame is predicted. A “B” frame may be a frame that has been compressed using data from one or more preceding frames (e.g., the closest preceding I or P frame) and/or one or more following frames (e.g., the closest following I or P frame). “B” may indicate that the frame is “bidirectional,” which may indicate that the frame may depend on frames that occur before and after it in a video sequence. A group of pictures, or GoP, may be a series of frames comprising an I frame (e.g., a single I frame) and zero or more P and/or B frames. A GOP may begin with an I frame and end with the last frame before the next I frame. The frames (e.g., all of the frames) in the GoP may depend (e.g., directly or indirectly) on the data in the initial I frame. Open GoP and closed GoP may be terms that refer to the relationship between one GoP and another GoP. A closed GoP may be self-contained (e.g., none of the frames in the GoP may refer to or be based on frames outside the GoP). An open GoP may use data from another GoP (e.g., the I frame of the following GoP) for calculating some of the B frames in the open GoP. For example, I frame 302 shown in FIG. 3 may be the first frame of the next GoP, and B frames 11 and 12 may be based on this I frame because the example structure may be an open GoP structure.

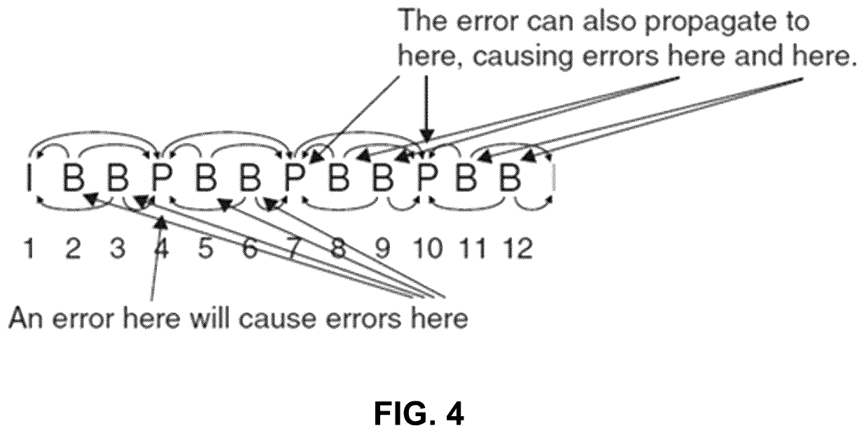

Packets of the same video stream but of different frame types (e.g., I/P/B frame) or different positions in the GoP may have different levels of contributions to a user's experience. FIG. 4 illustrates an example in which an error on the P frame 4 may cause errors on B frames 2, 3, 6 and 7. The error may also propagate to P frame 7 and P frame 10, causing errors to B frames 8, 9, 11 and 12.

Video compression techniques may be used to encode a video stream into multiple video layers, which may enable refinement (e.g., progressive refinement) of a reconstructed video at a receiver. Video distribution may support scenarios with heterogeneous devices, unreliable networks, and/or bandwidth fluctuations. The multiple video layers may include a base layer (BL) and/or one or more enhancement layers (ELs) that may rely on the BL. An EL may be further relied upon by other ELs. The base layer and the enhancement layer(s) may be associated with the same video content and, when processed together with the base layer, the enhancement layer(s) may improve the quality of the video content. If a BL of video data or an EL of video data is lost or corrupted during its transmission, the dependent layers may not be usable by a decoder and may be dropped.

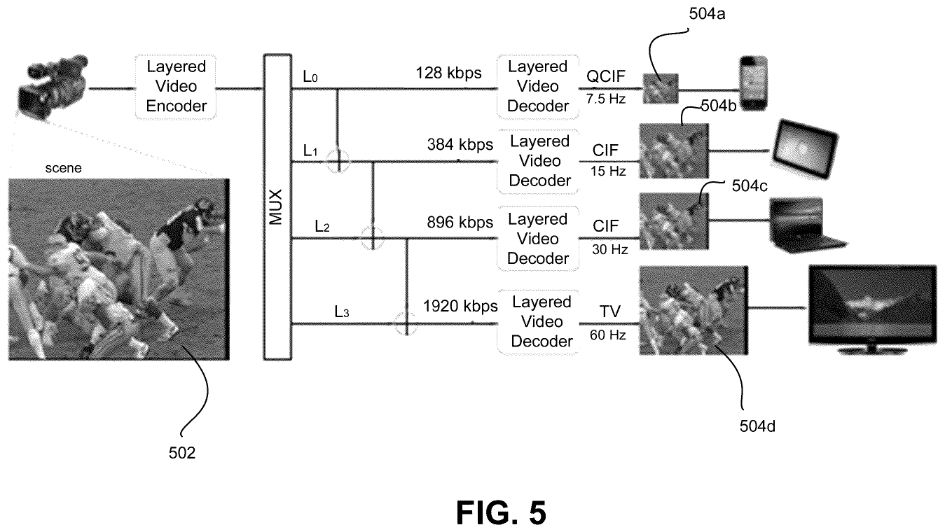

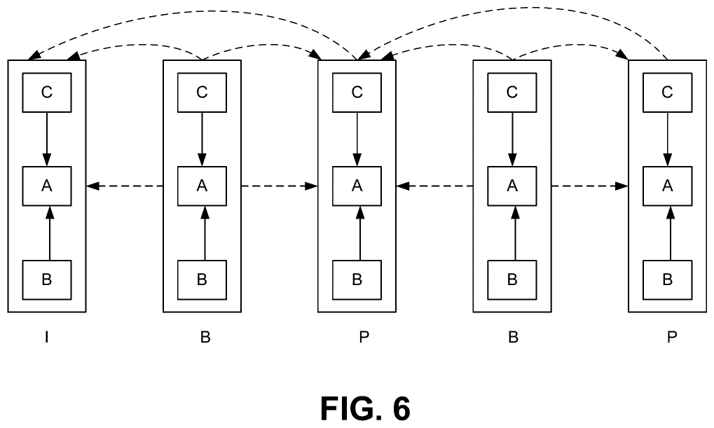

FIG. 5 illustrates examples of a multi-layer video stream over the length of a GoP, in which a scene 502 may be encoded into multiple layers and subsequently decoded (e.g., at a decoder side) into different versions (e.g., 504a-504d, which may correspond to different layers) for different devices. FIG. 6 illustrates examples of video layers in a video stream, which may be referred to as partitions A, B and C). In the examples of FIG. 6, “B→A” may indicate that partition B may depend on partition A, while “B→I” may indicate that frame B may be predicted from frame I.

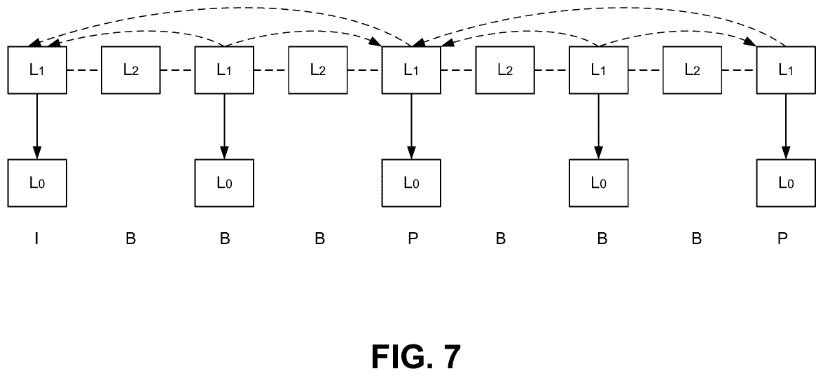

FIG. 7 illustrates an example of video layer dependency in a scalable video coding (SVC) stream. Video layers L0, L1, and L2 in the figure may represent a BL, a spatial EL and a temporal EL, respectively. “→” may indicate “depends on”, while “→” may indicate “is predicted from.”

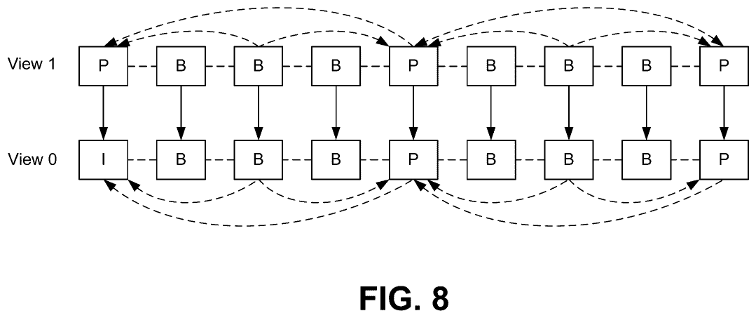

FIG. 8 illustrates an example of frame dependency in a multi-view video coding (MVC) stream. In this example, “→” may indicate “depends on”, while “→” may indicate “is predicted from.”

In the present disclosure, video data may be used as an example of multi-modal data that may include more than a single modality of data. A single-modal data may be interpreted as a video frame or a video layer within the video frame, depending on whether the video frame includes more than one video layer.

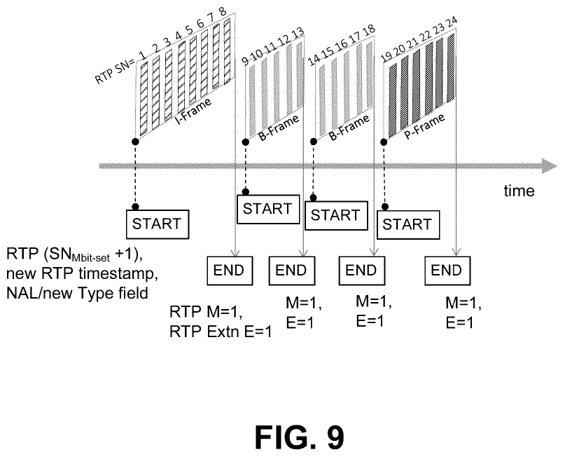

A PDU set may be transmitted within a radio bearer or a QoS flow. Application data may be transported over a transport network in a cellular system. The application data may be packetized. Examples of such packets may include RTP packets or RTP PDUs. FIG. 9 illustrates an example of a video stream packetized into RTP PDU packets.

Packets within an application data frame may depend on each other since the application may use the packets for decoding the application data frame. A lost packet may make other correlated packets useless even if they are successfully transmitted. For example, an XR application may impose requirements (e.g., QoS requirements) in terms of media units (or application data units) rather than packets or PDUs. A PDU set may be defined, which may include one or more PDUs carrying the payload of a unit of information (e.g., a media data unit) generated at the application level (e.g., the media data unit may be a video frame, a video slice, a video layer for video XRM services, or single-modal data within multi-modal data). In some implementations, the PDUs (e.g., all of the PDUs) in a PDU set may be used by an application layer (e.g., the corresponding unit of information may be used by the application layer). In some implementations, the application layer may recover parts (or all) of an information unit, if some PDUs are missing.

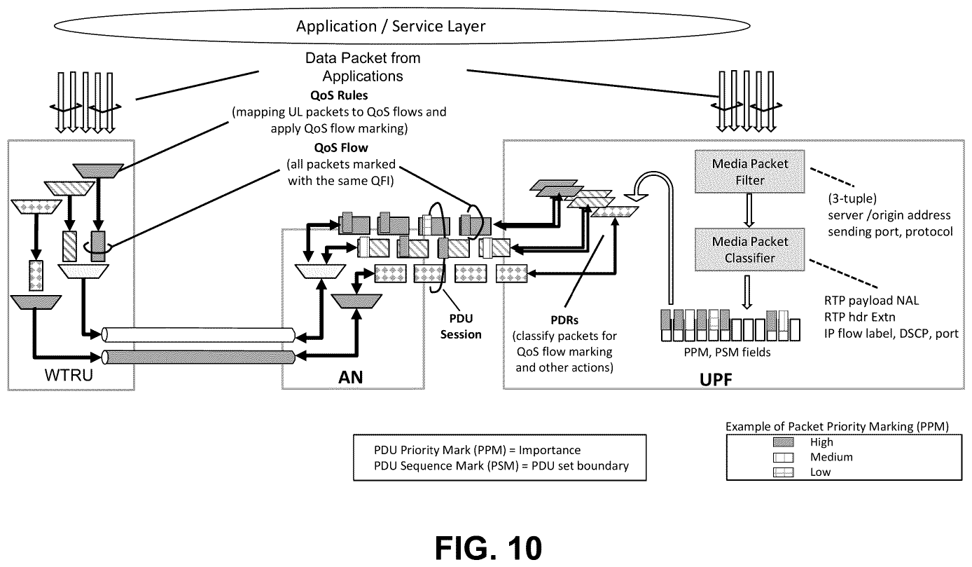

Within a QoS flow or a radio bearer, packets of a packetized media data unit may have different importance or priorities, e.g., as illustrated in FIG. 10. It should be noted that a QoS flow may be associated with a QoS differentiation granularity (e.g., the finest QoS granularity) in a PDU session. Similarly, a bearer may be associated with a QoS differentiation granularity (e.g., the finest granularity) for bearer-level QoS control in a radio access network (RAN) or a core network (CN). One or more QoS flows may be mapped to a radio bearer (e.g., in the RAN). In the example of FIG. 10, the bearer may correspond to access network (AN) resources illustrated by the tunnels between the access network and a WTRU.

XR media (XRM) PDUs may depend on each other. The PDUs (e.g., an I frame, a base layer of video data, first single-modal data of multi-modal data, etc.) that may be depended by other PDUs (e.g. a P frame, a B frame, an enhancement layer of video data, second single-modal data of the multi-modal data, etc.) may be associated with a higher priority or importance, may be transmitted first, and/or may be provided with different scheduling and error resiliency treatments. For example, in some video XRM services, P frames and B frames may be as important as I frames for constructing a fluent video, so the dropping of those P frames and/or B frames may cause jitter to the video and the quality of experience (QoE) of a user. In other video XRM services, P frames and/or B frames may be used to enhance the resolution of video content, e.g., from 720p to 1080p, so the dropping of those P frames and/or B frames may be acceptable in order to keep the service uninterrupted (e.g., when network resources may not be available to transmit all of the service data).

PDUs with the same priority or importance level within a QoS flow or bearer may be treated as a PDU set (e.g., a PDU set may be associated with a video frame, a video layer such as a BL or EL, single-modal data within multi-modal data, etc.). XRM service data may be grouped into a list of PDU sets (e.g., consecutive PDU sets). The QoS requirement for an XRM service may be consistent across multiple PDUs (e.g., except for importance levels). Hence, an XRM service flow may be mapped into a QoS flow, which may include a plurality of PDU sets with respective (e.g., different) importance levels or priorities. A (e.g., each) PDU set may include multiple PDUs. A (e.g., each) PDU set may be associated with one or more of the following properties (e.g., which may be included in a PDU set header). The PDU set may be associated with a sequence number for the PDU set. The PDU set may be associated with an importance level of the PDU set. The PDU set may be associated with boundary information such as a start mark of the PDU set and/or respective sequence numbers of the PDUs within the PDU set. For example, the PDU set may be associated with a start mark, which may be valid for (e.g., only for) the first PDU of the PDU set. As shown in the example of FIG. 10, the network may not know whether a current PDU is the last PDU of a current PDU set (e.g., unless the next PDU is the first PDU of another PDU set). The last PDU of a PDU set may not be marked and the first PDU of the PDU set may be marked (e.g., to avoid waiting for the next PDU to determine whether a currently received PDU is the last PDU of the PDU set). The sequence numbers of the PDUs within the PDU set may allow for out-of-order detection and/or reordering of the PDUs.

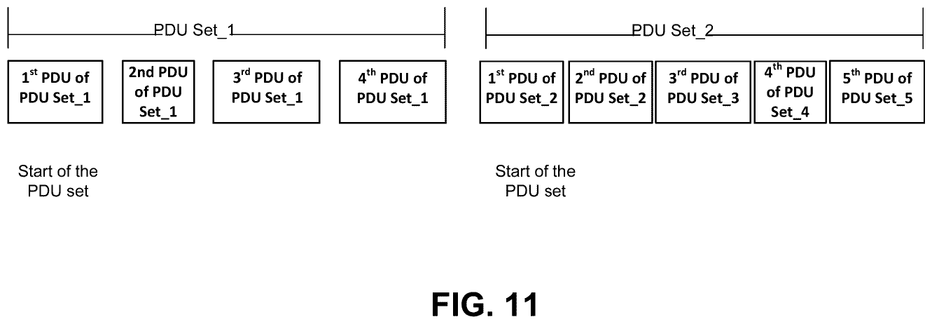

A current PDU set may be associated with the sequence number of another PDU set on which the current PDU set may depend. For example, if PDU set 2 is dependent on PDU set 1, PDU set 2 may carry the sequency number of PDU set 1. FIG. 11 illustrates examples of PDU sets. An illustration of a PDU set header is shown in Table 1 below.

TABLE 1
An example of a PDU header

| | |
|---|---|
| PDU Set header | Importance level |
| | Sequence number of the PDU Set |
| | Sequence number of the PDU within the PDU Set |
| | Start Mark of the PDU Set, |
| | only valid for the 1st PDU of the PDU Set |
| | Dependent PDU Set's sequence number |

The term “layer” or “video layer” may be used in this disclosure to correspond to different things depending on the context of the use. For example, the term “video layer” may correspond to a PDU set, where the PDU set (e.g., the PDUs within the PDU set) may be given differentiated transmission treatment or reception treatment in a cellular system access stratum (AS) or non-access stratum (NAS) (e.g., the treatment may be differentiated based on the relative importance or priority of the PSU set as illustrated in FIG. 10 and Table 1).

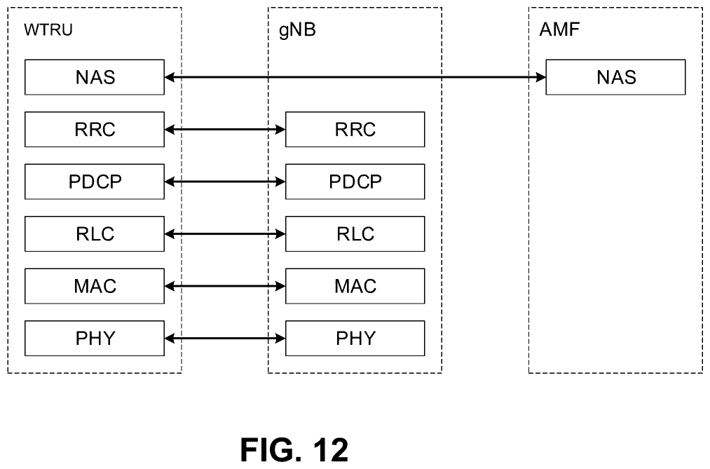

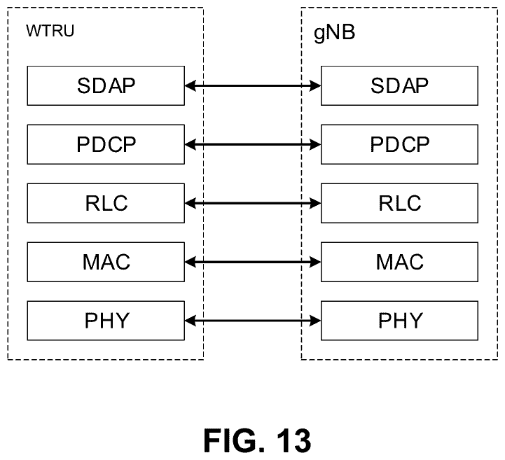

The functions of telecommunication systems such as cellular communication systems may be structured into distinct groups of related functions (e.g., which may be referred to as protocol layers). FIG. 12 and FIG. 13 illustrate examples of protocol stack layers for a control plane and a user plane, respectively. The control plane may include the following protocol layers: PHY, MAC, RLC, PDCP, RRC and/or NAS. The user plane may include the following protocol layers: PHY, MAC, RLC, PDCP, and/or SDAP. An access stratum may include the following layers: PHY, MAC, RLC, PDCP, and/or SDAP. The term “protocol layers” may be used in this disclosure to refer to different concepts. From the perspective of a given protocol stack layer, a protocol stack upper layer may refer to one or more protocol stack layers that are above this protocol layer, and a protocol stack lower layer may refer to one or more protocol stack layers that are below this protocol layer. For example, from a PHY protocol stack layer perspective, a protocol stack upper layer may include the RRC layer, while from an RRC perspective, a protocol stack upper layer may include the NAS layer or an application layer. As another example, from an SDAP perspective, a protocol stack upper layer may include an network internet protocol (IP) layer, a transport RTP protocol stack layer, or an application layer, while a protocol stack lower layer may include the PDCP layer.

It should be noted that while a PDU may be referred to as an RTP PDU in some examples provided herein, a PDU may also refer to an access stratum protocol layer PDU, for example, in the context of differentiated PDU set transmission treatment or reception treatment. It should also be noted that an RTP PDU may be segmented into an access stratum protocol layer PDU or aggregated into an access stratum protocol layer PDU.

MIMO layers or MIMO spatial layers may correspond to independent data streams that may be transmitted between a base station and one or more users simultaneously. Single-user MIMO (SU-MIMO) may provide the ability to transmit one or multiple data streams or MIMO layers from a transmitting array to a user (e.g., a single user). The number of layers that may be supported (e.g., which may be referred to as ranks) may depend on a radio channel. In multi-user MIMO (MU-MIMO), the base station may simultaneously send different MIMO layers in separate beams to different users using the same time and frequency resource(s), thereby increasing the network capacity.

XR and/or multi-modal traffic may share common characteristics (e.g., regardless of which codec is used to encode or decode the traffic) and these characteristics may be useful for improving transmission control and transmission efficiency, for example, if the characteristics are conveyed to and used by the network (e.g., an RAN). The network (e.g., a core network or RAN) may be informed about media application attributes, for example, beyond what is allowed in a legacy cellular system QoS framework. Such attributes may include information such as the relative importance of a PDU set within the PDU sets derived from the packetization of a media data stream, the scheduling deadline of PDUs within a PDU set, content delivery criteria for PDUs within a PDU set (e.g., such as “all or nothing,” “good until first loss,” or “FEC with either static or variable code rate”). Content delivery criteria may aim at defining whether to deliver or discard a PDU in a PDU set after missing the delivery or reception deadline of the PDU, in response to determining that the content criteria of an associated PDU set can no longer be fulfilled, or in response to determining that the content criteria of the associated PDU set have already been fulfilled.

Differentiated transmission treatment or reception treatment may be provided to PDU sets and their corresponding PDUs, considering the relative importance or priority of the PDU sets and/or their corresponding PDUs within a QoS flow or bearer (e.g., as per the QoS framework for media PDU classification illustrated in FIG. 10). For example, different modulation and coding schemes (e.g., different modulation orders and/or coding rates) may be applied to support differentiated transmission treatment or reception treatment of PDU sets and their corresponding PDUs (e.g., by making the relative importance or priority of the PDU sets and/or their corresponding PDUs visible to the physical layer). Using video data as an example (other data types may also be supported by the techniques disclosed herein), a video base layer (video BL) may be provided with more robust error protection than a video enhancement layer (video EL), for example, via the use of a less aggressive MCS. More important video ELs (e.g., those with higher priority) may be provided with more robust error protection than less important video Els (e.g., those with lower priority).

Video data (e.g., layered video data) may be used herein as an example to describe the proposed techniques. Those skilled in the art will understand, however, the proposed techniques are not limited to processing video data or video layers and may be used to process other types of data as well. To that extent, the term “video layer” used herein may be understood to refer to a PDU or a PDU set comprising PDUs of certain characteristics (e.g., having certain importance/priority). For example, a video base layer in the examples provided herein may be understood to refer a PDU or a PDU set that may be given the same importance/priority as the video base layer. A video enhancement layer in the examples may be understood to refer to a PDU or PDU set that may be given the same importance/priority as the video enhancement layer. While the term “video layer” may be used in this disclosure to describe processing associated with a PHY protocol layer (e.g., in support of differentiated transmission treatment or reception treatment of different PDU sets), those skilled in the art will understand that the disclosure more generally proposes that the RAN protocol stack (e.g., not limited to the PHY layer) may treat PDU sets or PDUs differently based on the type of data (e.g., video layers) carried in the PDU sets or PDUs (e.g., based on the importance or priority of the PDU sets or PDUs).

The capabilities of a WTRU may be reported to or otherwise exchanged with the network (e.g., a base station) to enable unequal error protection (WTRUP) of various types of data (e.g., such as video data). One or more of the following WTRU capabilities may be reported to a network device such as a base station (BS) to enable reliable data (e.g., video data) transmissions. Along with the various capabilities reported by the WTRU to the BS to enable the proposed framework (e.g., such as a supported modulation order for the DL and/or UL, a max bandwidth (BW), and/or a subcarrier spacing), the WTRU may report to the BS information regarding the WTRU's capability to differentiate between different video layers (e.g., carried in a PDU set comprising multiple PDUs) at a certain protocol stack layer (e.g., one or more lower protocol stack layers), to support differential treatment of video layers, to support differential treatment of video frames, to support differential treatment of video frames within a GoP, to support differential treatment of video frames across GoPs, to modulate/demodulate different video layers using different constellation diagrams or schemes (e.g., simultaneously), to code/decode different video layers separately, to jointly encode/decode different video layers at one or more high protocol stack layers, at one or more low protocol stack layers, or at both high and low protocol stack layers (e.g., in support of video layer aware forward error correction (LA-FEC) also known as inter-video layer forward-error-correction (IL-FEC)), etc.

The capability to differentiate between different video layers at lower protocol stack layers (e.g., the PHY layer) and/or other WTRU capabilities described herein may allow (e.g., may be a prerequisite) for enabling the proposed video transmission framework. One or more of the WTRU capabilities described herein may alter PHY-based WTRU procedures for video transmission. It should be noted that the techniques described in this disclosure may apply to any device that implements one or more of the capabilities described herein. Example of such devices may include not only smart phones and tablets, but also IoT devices for low cost, low power wide area network applications and mid-tier cost reduced capability (REDCAP) devices (e.g., for industrial wireless sensor network (IWSN) applications), the examples of which may include power meters, parking meters, secure monitoring video cameras, connected fire hydrants, connected post boxes, etc. The use cases for the disclosed techniques may include applications that generate both uplink and downlink video traffic, or applications that generate either uplink or downlink video traffic. The techniques described in this disclosure may also apply to multi-modality traffic that may or may not include video traffic. Such multi-modality traffic may include, for example, audio traffic, sensor related traffic (e.g., temperature, humidity, pressure, smell, etc.), or haptic data (e.g., pressure, texture, vibration, and/or temperature data associated with touching a surface). Such traffic (or data) may be generated in support of immersive reality applications, which may be denoted herein as XR applications. Such traffic may be formatted in different levels of resolution, different levels of accuracy, or different levels of precision. The levels of resolution, accuracy or precision may correspond to layers of video traffic (or other equivalent terms as defined in this disclosure). The techniques described herein (e.g., for unequal error protection) may apply to other types of traffic as well.

The techniques described in this disclosure may apply to a radio access technology (RAT) such as a cellular RAT, and/or an 802.11 WLAN (Wi-Fi) RAT that may support the capabilities described herein. The techniques and procedures may be described in the context of a Uu interface (e.g., for interactions between a WTRU and a base station), but they may also be used for communications over a sidelink interface, such as, e.g., a PC5 interface.

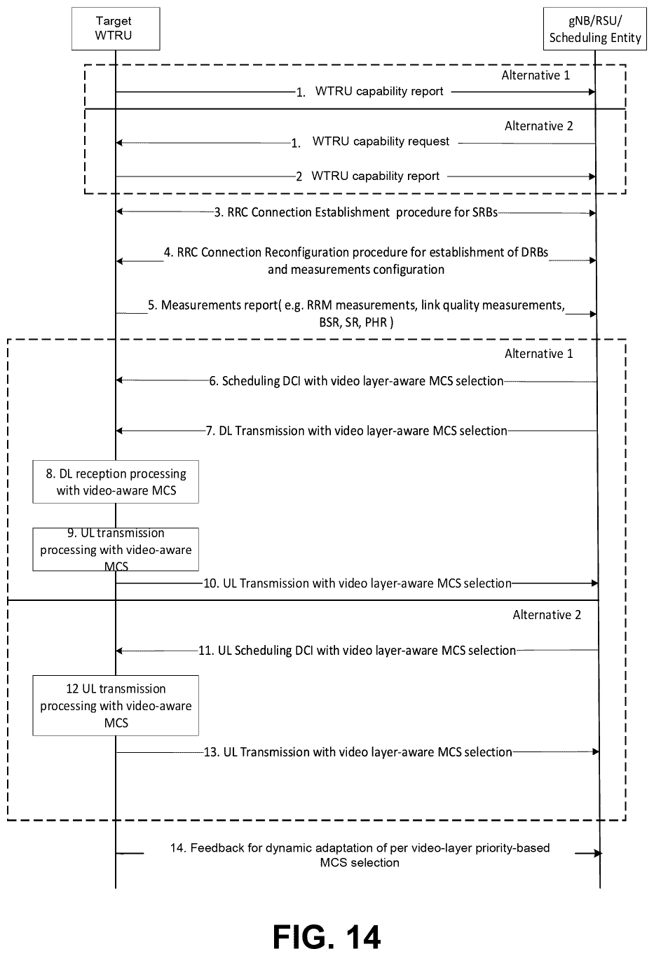

FIG. 14 illustrates an example of a video layer-aware scheduling method as described herein, which may include one or more of the following operations. At 1 and 2: a WTRU may signal (e.g., report) its capability to a scheduler (e.g., a network device such as a base station). The signaling may be performed by the WTRU, for example, autonomously based on a trigger from a protocol stack layer (e.g., an upper protocol stack layer) of the WTRU, or in response to a request from the scheduler. At 3 and 4: the WTRU may establish an RRC connection and one or more signaling bearers associated with the RRC connection (e.g., including one or more data radio bearers), for example, through an RRC setup or RRC reconfiguration procedure. The WTRU may be configured with measurement and reporting configuration as part of the RRC setup or RRC reconfiguration procedure.

At 5: the WTRU may report measurements to the scheduler. The measurements may include measurements to support a scheduling operation, including transport volume measurements, RRM measurements, and/or other link quality evaluation related measurements (e.g., such as an experience block error rate, a bit error rate, a packet error rate, and/or other metrics or quantities that may measure the deviation between a targeted QoS/QoE and an actual QoS or QoE). Examples of these measurement reports may include a buffer status report (BSR), a scheduling request (SR) (e.g., to request resources for the BSR report), a power headroom report (PHR), etc. For the BSR, PHR or SR, the WTRU may report the measurements on a per video-layer (e.g., per PDU set) basis so that the scheduler may have visibility into the uplink scheduling that the WTRU may request (e.g., at the level or granularity of a video layer or other video partitions). It should be noted that two or more video layers may be associated with the same bearer or QoS flow. The WTRU may report the measurements at a granularity level that may enable the scheduler to have visibility into the WTRU's scheduling needs beyond the granularity of the QoS treatment differentiation level offered by an existing QoS flow or bearer framework (e.g., for the uplink and/or downlink). Other examples of measurements that may be reported by the WTRU may include RSRP, RSRQ, RSSI, SINR or CSI, etc.

At 6, the WTRU may receive a scheduling DCI with one or more scheduling parameters (e.g., for DL reception with video layer-aware MCS based processing, or for UL transmission with video layer-aware MCS based processing). At 7 and 8, the WTRU may perform DL reception with video layer-aware MCS processing based on received RRC configuration information and/or the scheduling DCI described herein. At 9 and 10, the WTRU may perform an UL transmission with video layer-aware (e.g., video layer-based) MCS processing based on received RRC configuration information and/or the scheduling DCI described herein.

At 11, 12 and 13, the WTRU may (e.g., as alternatives to one or more of the operations described above) receive DCI scheduling an uplink transmission but not a downlink reception. For example, at 12, the WTRU may receive a scheduling DCI with one or more scheduling parameters for UL transmission with video layer-aware MCS processing. At 13 and 14, the WTRU may perform a UL transmission with video layer-aware MCS processing based on received RRC configuration information and/or the DCI scheduling information described herein.

At 14, the WTRU may provide feedback to the scheduler. The feedback may include one or more additional measurements in support of DL/UL scheduling. The feedback may include HARQ feedback, the WTRU's recommendation for video layer based MCS selection for subsequent DL/UL scheduling, and/or the WTRU's recommendation for switching to a single constellation-based method, a separate constellation-based method, or a hybrid constellation-based scheme. The feedback may be transmitted jointly with an UL transmission to the scheduler.

A physical layer in a protocol stack may be configured to identify data belonging to different video layers and apply differential treatment to the video layers (e.g., for each video layer). For example, the physical layer may be configured to treat a video base layer differently from a (e.g., each) video enhancement layer at various PHY processing stages. The physical layer may be configured to transmit different video layers simultaneously.

Video data (e.g., a video stream) may be partitioned into blocks, where each block of data may be associated with one or more of the following properties: the video frame that the block of data may belong to, the video layer that the block of data may belong to, and/or the video GoP that the block may belong to. It should be noted that while the techniques (e.g., UEP techniques) described in this disclosure may be expressed in terms of differentiated treatment of video layers, the techniques may also be applied to differentiated treatment of the aforementioned video data blocks. For example, the techniques described in this disclosure may be applied to the differentiated treatment of video frames, or a combination of video frames and video layers. The techniques described in this disclosure may also be used for differentiated treatments of video layers within a video frame, or video layers across video frames. For simplicity of description, the techniques may be presented in terms of one video base layer and/or one video enhancement layer, but the techniques may also be used when there are a video base layer and multiple video enhancement layers. While video data may be used to describe the techniques, the techniques may be applies to other types of data.

Modulation constellation schemes may be assigned to video layers. Different modulation and coding schemes may be applied as an example of differentiated treatment of video layers at a WTRU, at a base station, or at another controlling or scheduling device or entity. One or more of the following modulation constellation assignment schemes may be implemented: a single root constellation-based scheme, a separate-root or multi-root constellation-based scheme, and/or a hybrid constellation scheme. A root constellation may be defined and/or configured for a WTRU, for example, based on a maximum modulation order that may define possible modulation constellation points.

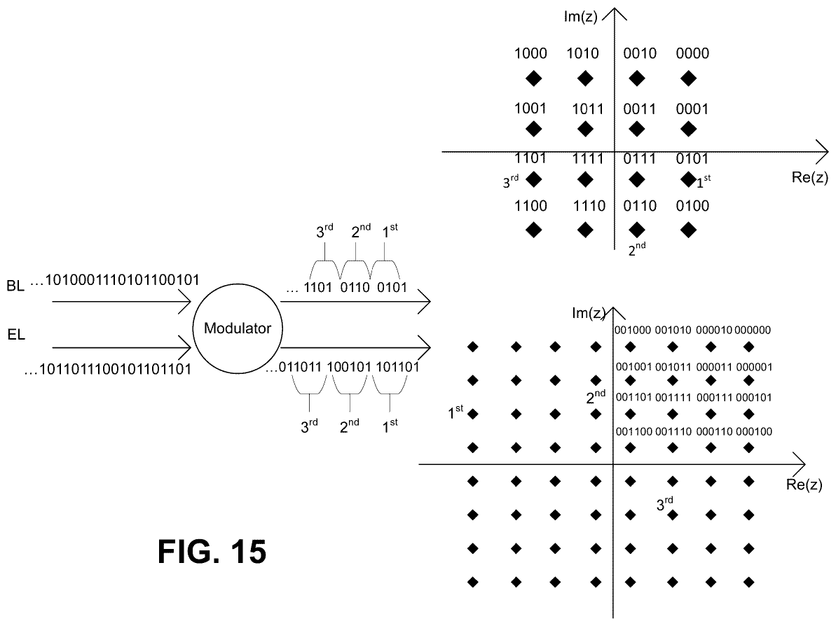

In an example of the single root constellation scheme, modulation constellations applied to the various layers of a video may be derived from the same root constellation, for example, based on a video layer specific minimum distance between modulation constellation points and the number of bits within the set of bits allocated to a modulation symbol (e.g., as illustrated by FIG. 15). Constellations may be assigned to one or more video layers in a hierarchical manner. For example, assuming a video has a video base layer BL and video enhancement layers L1 and L2, the modulation constellation of video layer L1 may be derived from the modulation constellation of the video BL, while the modulation constellation of video layer L2 may be derived from the modulation constellation for video layer L1.

In an example of the separate-root constellation scheme, the modulation constellations applied to the various layers of a video may be derived from two or more root constellations. A scheduler may use different constellation sets for different video layers. As another example, the different layers of the video may be grouped into subgroups of video layers and the scheduler may use the same constellation for video layers of the same subgroup, and use different constellations for the video layers of different subgroups.

In an example of the hybrid constellation scheme, a single root constellation scheme and a separate-root constellation scheme may be combined. In examples, a first root constellation may be assigned to a video base layer, and a second root constellation may be assigned to a video enhancement layers, wherein a single root constellation scheme may be used for modulation constellation assignment to each video enhancement layer, using the second root constellation. For example, assuming the video includes one or more video enhancement layers, the second root constellation may be assigned to a first video enhancement layer, and the one or more modulation constellations of the remaining one or more video enhancement layers may be derived from the second root constellation in a hierarchical manner following the single root constellation scheme. For example, assuming the video includes a video base layer BL layer and video enhancement layers L1, L2 and L3, the first root constellation may be assigned to the video base layer BL, the second root constellation may be assigned to the video enhancement layer L1, the modulation constellation of video enhancement layer L2 may be derived from the second root constellation, while the modulation constellation of the video layer L3 may be derived from the L2 modulation constellation.

The terms “hierarchical modulation,” “single-constellation scheme,” and “single-constellation diagram” may be used interchangeably herein. The terms “single root constellation-based scheme,” “single constellation-based scheme,” and “single constellation scheme” may be used interchangeably herein. The terms “separate root constellation-based scheme,” “multi-root constellation-based scheme,” “separate constellation-based scheme,” “multi-constellation-based scheme,” “multi-root constellation scheme,” and “separate constellation scheme” may be used interchangeably herein.

Modulation-based UEP for video layer specific constellations may be implemented. Separate modulation-based UEP schemes driven by a constellation scheme may be applied according to WTRU capabilities, channel conditions, scheduling constraints, and/or other system considerations. With a modulation-based UEP scheme, different video layers may be modulated differently according to their importance (e.g., priority). For instance, bit streams from high-importance or high-priority video layers (e.g., a video BL) may be modulated using a low-modulation order, while bit streams from low-importance or low-priority layers (e.g., a video EL) may be modulated using a high-modulation order.

A network (e.g., a BS) may leverage a modulation-based UEP scheme based on the capability reported by the WTRU to the network. The WTRU may receive from the network configuration information (e.g., via RRC signaling) indicating a modulation-based UEP scheme to be used to modulate a data transmission or to demodulate a data reception.

Separate modulation-based UEP schemes (e.g., driven by a constellation scheme) may leverage disparate constellation diagrams, where bit streams from different video layers may be modulated separately using two or more different constellation diagrams (e.g., as illustrated by FIG. 15). A constellation diagram may be referred to herein as a constellation set, which may include multiple constellation subsets. A (e.g., each) constellation subset may include one or more constellation points. The terms “constellation region” and “constellation subset” may be used interchangeably herein.

The WTRU may receive from a base station (BS), e.g., via RRC signaling, configuration information regarding a modulation scheme to be used. If the configuration information received by the WTRU includes more than one modulation scheme, the configuration information may also indicate whether a modulation scheme is activated or deactivated. The WTRU may receive via a MAC CE, DCI, or sidelink control information (SCI) signaling, an activation or deactivation indication or command for a modulation scheme configured for the WTRU (e.g., via RRC signaling).

The WTRU may receive from the BS UL/DL information (e.g., as part of scheduling parameters or together with scheduling parameters) that the WTRU may use to provide differentiated treatment (e.g., at the PHY layer) for different video layers (e.g., in terms of the modulation and coding schemes applied to the different video layers). The WTRU may receive the information together with scheduling parameters from the BS for DL data reception, for example, via DCI messages in support of dynamic or semi-static scheduling. The WTRU may receive the information together with scheduling parameters from the BS for UL data transmission, for example, via DCI messages in support of dynamic scheduling. The WTRU may receive the information via RRC signaling. Differentiated treatment of video layers may include receiving differentiated modulation and coding scheme (MCS) schemes or parameters (e.g., constellation sets) for a video base layer and one or more video enhancement layers, and processing the video base layer and the one or more video enhancement layers differently, for example, by mapping different symbols to different time-frequency resources (resource elements or REs) and/or different MCS schemes or parameters according to the respective video layers that the symbols may belong to.

A scheduler (e.g., a base station) may use different constellation sets for different video layers, as shown in FIG. 15. The WTRU may receive a modulation order for a (e.g., each) video layer with which the WTRU may modulate (or demodulate) a PUSCH (or PDSCH) associated with the video layer during UL transmission (or DL reception). In a separate-constellation-based scheme, the WTRU may receive different MCS allocation parameters (e.g., different constellation schemes) and/or different time-frequency domain resources for different video layers, and map different MCS parameters (e.g., constellation schemes) and/or time-frequency resources to different video layers.

The WTRU may receive one or more modulation related parameters. With a separate-constellation approach, the WTRU may identify the modulation order for modulating/demodulating the PUSCH/PDSCH during UL/DL communications. The parameters that the WTRU may receive from a BS to enable a separate constellation-based UEP framework may include an MCS index, a reference video layer (e.g., a video BL or video EL) that may indicate the video layer to be modulated with the received MCS index, the modulation order for a video layer, allocated time symbols for a video layer, allocated frequency resources for a video layer, etc.

The WTRU may use a MCS table from a set of differently defined MCS tables for determining the modulation order and coding rate to be used, for example, based on a received MCS index. The WTRU may determine the MCS table from which to select the modulation and coding scheme based on a received RRC signaling, a received DCI, and/or the RNTI used to scramble the CRC associated with the received DCI. The modulation parameters (e.g., a modulation order) for a video layer may be received by the WTRU in a dynamic or a semi-static manner. For instance, the WTRU may receive a number indicating the modulation order for the video layer, or the WTRU may receive an index pointing to a row in an RRC-configured table defining a set of modulation orders for the video layer. The WTRU may be configured to use a dynamic and/or semi-static approach, e.g., via RRC signaling. The activation or deactivation command of a configured modulation scheme (e.g., configured via RRC signaling) may be transmitted via a MAC CE, DCI, or SCI signaling.

The WTRU may receive one or more of the parameters described herein as a part of a DCI message (e.g., preceding a DL transmission on the PDSCH under dynamic and/or semi-persistent scheduling). The WTRU may receive one or more of the parameters described herein as a part of a DCI message granting UL transmission resources (e.g., on the PUSCH) under dynamic scheduling and/or configured grant (CG) type 2. The WTRU may receive one or more of the parameters described herein as a part of RRC signaling granting UL transmission resources (e.g., on the PUSCH) under CG type 1.

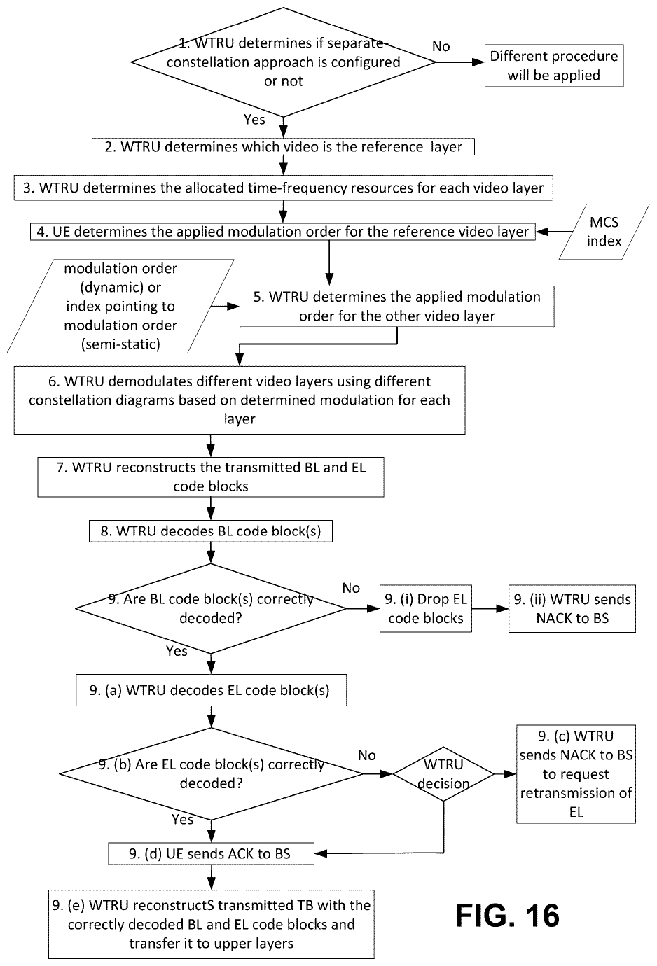

The WTRU may perform one or more of the following actions in a separate-constellation UEP framework (e.g., during a DL transmission). The WTRU may receive allocated time and frequency resources for a (e.g., each) video layer, and the WTRU may determine the REs that may carry data associated with the video layer. FIG. 16 illustrates an example of a PDSCH transmission that may include data associated with multiple video layers within an allocated slot for DL reception.

The WTRU may determine whether it is configured with a separate-constellation modulation scheme, for example, based on RRC signaling and/or an indication to activate/deactivate different UEP-based modulation schemes that the WTRU may receive via a DCI message, a MAC CE, or SCI signaling. If such a separate-constellation modulation scheme is configured, the WTRU may proceed with one or more of the following operations. The WTRU may determine which video layer is a reference video layer (e.g., a video BL or video EL) based on a received parameter indicating the reference video layer. The WTRU may determine the allocated time-frequency resources for the reference video layer and/or other video layer(s) based on received time and frequency allocation parameters in a DCI message. The WTRU may determine the modulation order (M_1) and/or coding rate used to modulate and encode the reference video layer based on a received MCS index and/or by determining from which table this MCS index may be selected. As described herein, the WTRU may be (pre) configured with MCS tables (e.g., one or more MCS configuration look-up tables), and the received MCS index may point to an MCS configuration in an MCS table. The MCS configuration pointed to by the received MCS index may include the modulation order M and/or the coding rate. The WTRU may determine the applied modulation order for the other video layer(s) (M_2) based on a configured operation (e.g., dynamic or semi-static) and/or parameters received through a DCI message indicating the applied modulation order. The WTRU may create constellation sets (e.g., two constellation sets) based on M_1 and M_2 to demodulate the received reference video layer and the other video layer(s). The WTRU may, after the demodulation, assemble the obtained video BL bit streams from its allocated time-frequency resources (e.g., in a frequency-first, time-second manner) to reconstruct the video BL code block(s). The WTRU may reconstruct the video EL code block(s) in the same way. The WTRU may decode the video BL code block(s) based on the identified code rate described above. The WTRU may check if the video BL code block(s) are correctly decoded. If the BL code block(s) are correctly decoded, the WTRU may decode the video EL code block(s) based on the same code rate used to decode the BL. The WTRU may check if the video EL code block(s) is correctly decoded. If EL code block(s) is not correctly decoded, the WTRU may or may not request retransmission of the video EL (e.g., based on a desired QoS). If the WTRU requests retransmission of the video EL, the WTRU may send a NACK; if the WTRU does not request retransmission of the video EL or if the video EL code block(s) is correctly decoded, the WTRU may send an ACK. The WTRU may concatenate the correctly decoded code blocks of the video layers to construct a transport block to be transferred to a protocol stack upper layer. If the video BL code block(s) are not correctly decoded, the WTRU may drop the received video EL code block(s) and send a NACK to the BS for retransmission.

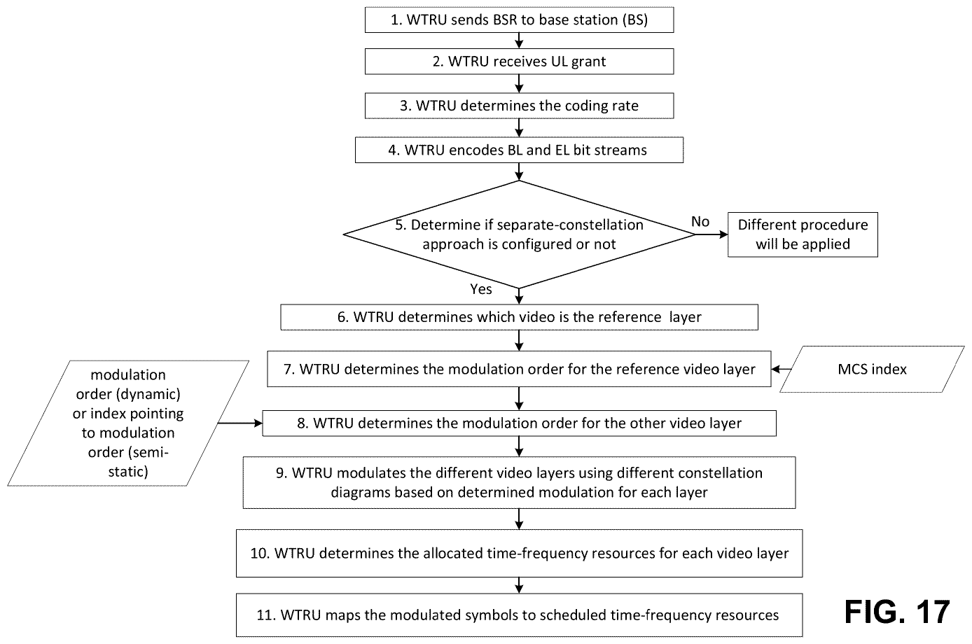

The WTRU may perform one or more of the following actions in a separate-constellation UEP framework (e.g., during a UL transmission). FIG. 17 illustrates examples of such actions with respect to performing a PUSCH transmission that may include data associated with multiple video layers within an allocated slot for the PUSCH transmission. The WTRU may send a buffer status report (BSR) to a BS (e.g., over the PUSCH as a part of a MAC CE). The BSR may notify the BS about the amount of data the WTRU may send for a (e.g., each) video layer. The WTRU may receive a UL grant along with scheduling-related parameters via a DCI message (e.g., if the WTRU is configured with dynamic scheduling or CG type 2) or via RRC signaling (e.g., if the WTRU is configured with CG type 1). The WTRU may determine the respective modulation orders and/or coding rates for encoding a video BL and/or a video EL, for example, by determining a received MCS index and the MCS table in which this MCS index may be included. As described herein, the WTRU may be (pre) configured with MCS tables (e.g., one or more MCS configuration look-up tables), and the received MCS index may point to an MCS configuration in one of those MCS tables. The MCS configuration pointed to by the received MCS index may include, for example, the code rate to be used by WTRU. The WTRU may encode a video BL bitstream and/or a video EL bitstream with the code rate to generate encoded video BL code block(s) and/or encoded video EL code block(s). The WTRU may (e.g., before proceeding with modulation) identify which modulation scheme or approach may be applied when modulating the bitstreams of the video layers. The WTRU may determine, based on RRC signaling and/or the activation/deactivation of different UEP-based modulation schemes that the WTRU may receive via a DCI messages, a MAC CE, or SCI signaling, whether the WTRU is configured with a separate-constellation modulation scheme. If such a separate-constellation modulation scheme is configured, the WTRU may proceed with one or more of the following. The WTRU may determine which video layer is the reference video layer (e.g., a BL or EL) based on a received parameter that may indicate the reference video layer. The WTRU may determine a modulation order (M_1) that the WTRU may use to modulate the reference video layer, for example, based on the received MCS index and by determining the MCS table that the received MCS index may be included (e.g., the MCS configuration pointed to by the received MCS index may include the modulation order M_1). The WTRU may determine a modulation order that the WTRU may use to modulate another video layer (M_2), for example, based on parameters received through a DCI message that may indicate the modulation order (e.g., if the WTRU is configured with dynamic or semi-static scheduling). The WTRU may create constellation sets (e.g., two constellation sets) based on M_1 and M_2 to modulate the bitstreams of the reference video layer and the other video layer, respectively. The WTRU may determine time-frequency resources (e.g., as subsets of a UL grant) for the reference video layer and the other video layer based on time and/or frequency allocation parameters that the WTRU may receive via a DCI message (e.g., a scheduling DCI indicates a UL grant) or RRC signaling. The WTRU may map the modulated symbols of each video layer to the determined time-frequency resources (e.g., to respective subsets of the UL grant), for example, in a frequency-first, time-second manner.

Layer specific time-frequency resource assignment and associated signaling may be implemented. Since different constellation sets may be used to modulate the bitstreams of different video layers, a (e.g., each) video layer may be assigned its own symbols. A scheduler (e.g., base station) may link the symbols of a video layer to a corresponding set of REs. A WTRU may determine or identify the time and frequency resources (e.g., as subsets of a grant) associated with a video layer's symbols. A video BL and a video EL may be transmitted simultaneously over a scheduled time slot. The WTRU may receive a video BL and video EL over different frequency resources or different time symbols. The WTRU may receive information (e.g., a bit in a DCI message or RRC signaling) that may indicate whether the transmission of a video BL and a video EL is carried out over different frequency resources or different time resources.

Different frequency resources may be allocated to a video BL and a video EL. Different frequency allocation types may be used to signal the allocated frequency resources to a WTRU. These frequency allocation types may be configured for the WTRU, for example, via a DCI message or RRC signaling. For instance, type 0 resource allocation (e.g., for DL and/or UL) may include a bitmap-based allocation. The frequency resources allocated to the WTRU may be in the form of RBGs, each of which may include a number of consecutive RBs. The number of RBs included in a RBG may be configured via RRC signaling, e.g., based on a BWP size, as illustrated in Table 2 below. Grouping RBs into a RBG may reduce signaling overhead.

TABLE 2
Number of RBs in a RBG under different
BWP sizes and RRC configurations

| BWP Size | Configuration 1 | Configuration 2 |
|---|---|---|
| 1-36 | 2 | 4 |
| 37-72 | 4 | 8 |
| 73-144 | 8 | 16 |
| 145-275 | 16 | 16 |

Type 1 (e.g., for DL and/or UL) resource allocation may be different from type 0 resource allocation. With type 1 resource allocation, the WTRU may receive a resource indication value (RIV) indicating the start RB and the number of contiguous RBs allocated to the WTRU. Type 2 (e.g., for UL) resource allocation may include an interlaced resource allocation. With this allocation type, the WTRU may be allocated an interlace of non-contiguous, equally spaced RBs. As shown in Table 3 below, the number of different RB interlaces may depend on the numerology (e.g., for numerology 0 and numerology 1, there may be 10 and 5 RB interlaces, respectively). The WTRU may receive an indicator of the allocated RB interlace(s), for example, via an RIV indicating the start interlace and the number of contiguous interlace indices (e.g., for numerology 0), or via a bitmap indicating the allocated interlaces (e.g., for numerology 1). The WTRU may determine the allocated resources by finding the intersection between the resource blocks of the indicated interlaces and/or the union of the indicated set of RB sets and intra-cell guard bands.

TABLE 3
Number of RB interlaces

| Numerology (μ) | Number of interlaces (M) |
|---|---|
| 0 | 10 |
| 1 | 5 |

WTRU may receive one or more frequency allocation schemes (e.g., dynamic signaling or semi-static manner via RRC signaling). The activation or deactivation of a frequency allocation scheme configured via RRC signaling may be done via a MAC CE, DCI or SCI signaling. The frequency allocation scheme received by WTRU may depend on the number of scheduled RBs, channel capacity, and the amount of video BL and video EL data to be transmitted.

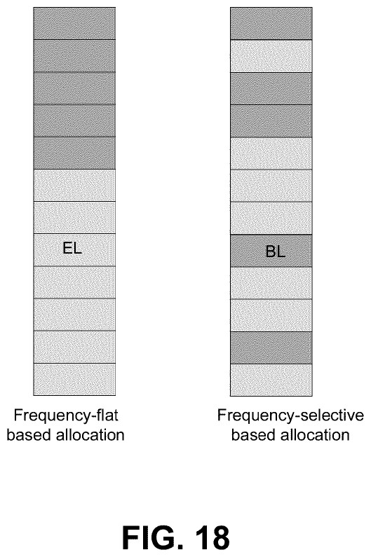

Video layer mapping may be performed with a resource element level granularity. A WTRU may receive a video BL and one or more video EL(s) over the same RBs, but over different subcarriers (e.g., as illustrated in FIG. 18). The video base layer and video enhancement layer(s) may use overlapping scheduled PRBs with non-overlapping sub-carriers (e.g., resource elements) within each PRB. With such a scheme, each of the video layers may achieve full frequency diversity that may be equal to the span of scheduled resource in the frequency domain.

Different resource element multiplexing patterns may be used to multiplex data from different layers or PDU sets. In an example multiplexing pattern, alternate resource elements may be used for each layer or PDU set. When such a pattern is used for multiple (e.g., two) layers, odd resource elements may be used for a first layer and even resource elements may be used for a second layer. If the number of encoded symbols is different for one layer versus another layer, a (e.g., each) layer may be assigned resource elements with a suitable pattern in a (e.g., each) resource block, and the pattern may be indicated by the network to the WTRU.

For a TDD and/or FDD-based UL transmission, a base station may determine, based on a UL reference signal transmitted from the WTRU (e.g., such as a sounding reference signal (SRS), if the WTRU experiences frequency-flat or frequency-selective fading across different subcarriers within a same RB. The same approach may be applied for a TDD-based DL transmission, where channel reciprocity may be leveraged to determine if the WTRU experiences frequency-flat or frequency-selective fading across different subcarriers within the same RB. For a FDD-based DL transmission, the WTRU may use a received reference signal such as a phase tracking reference signal (PTRS) to determine if the WTRU experiences frequency-flat or frequency-selective fading across different subcarriers within the same RB. If the WTRU experiences frequency-selective fading within the same RB, the WTRU may report the measurements it has for channel variations within the same RB to the BS, so that the BS (e.g., a scheduler) may allocate different video layers to different subcarriers accordingly.

If the WTRU experiences frequency flat fading across different subcarriers within the same RB, for a (e.g., each) scheduled RB, the WTRU may receive an indicator for a video layer that the WTRU may transmit or receive over a first set of subcarriers and/or the number of subcarriers that may carry the video layer. Having frequency-selective fading channels within the same RB may lead to a high level of granularity which in turn may lead to higher signaling overhead in terms of the amount of information that the WTRU may send (e.g., with respect to a FDD-based DL transmission) to identify the DL channel behavior across different subcarriers within the same RB. Having frequency-flat fading channels may alleviate the burden on the WTRU for differentiating between different subcarriers channel conditions. Allocating different subcarriers within the same RB for a video BL and a video EL may increase frequency-allocation-based signaling since (e.g., excess information for subcarrier allocation for each allocated RB may be received by the WTRU regardless of the type of channels that the WTRU may experience over different subcarriers).

Signaling for video layer mapping may be performed with a resource element level granularity. An indication for performing video layer mapping with the resource element granularity may be provided using different mechanisms. For example, a semi-static mapping indication may be provided or RRC configuration information may be used to provide the resource elements associated with a (e.g., each) video layer. As an example, odd numbered REs may be configured for a video BL while even numbered REs may be configured for a video EL. If there are multiple video ELs, odd numbered REs may be configured for a video BL, while even numbered REs may be configured for the ELs. Among the even numbered REs scheduled, alternating REs may be given to video EL1, video EL2, etc. The REs may be split as a function of the number of video layers supported and/or the relative coding rates for the supported video layers. A tabular form (e.g., a table) may be used to indicate the supported combinations of video layers, relative coding rates, and their associated RE splits in the allocated frequency resources. The network may choose a suitable split and may indicate the suitable split to the WTRU as part of the WTRU configuration.

A dynamic mapping indication associated with RE splitting may be provided. For example, RRC configuration information received by a WTRU may indicate a set of video layer mapping RE splits, and dynamic signaling may be provided to the WTRU (e.g., via DCI) to indicate (e.g., through a number of bits) which video layer specific RE split to use in the resources scheduled by the DCI. This may allow dynamic control of the video layer mapping over different REs and adaptation of the mapping in response to changing network dynamics and/or channel conditions.

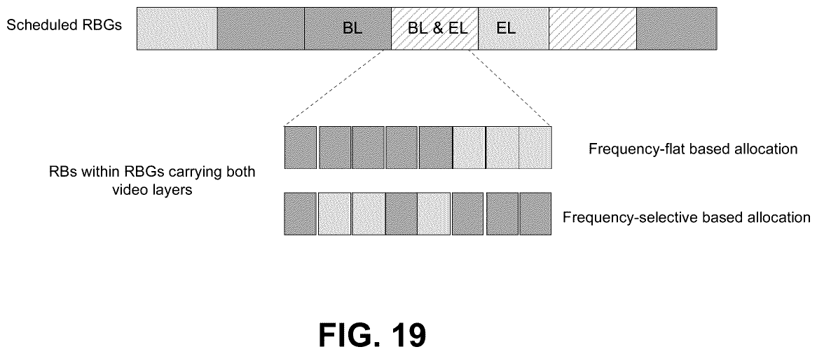

A video BL and a video EL may be mapped to different RBGs or different RBs within a same RBG. This approach may be adopted, for example, if the WTRU is configured with frequency allocation type 0 in which the WTRU may receive a bitmap indicating the allocated RBGs. In this approach, the video BL and video EL may be assigned to different RBGs or different RBs within the same RBG, as illustrated in FIG. 19.

For a TDD and/or FDD-based UL transmission, a base station may determine, based on a transmitted UL reference signal such as a sounding reference signal (SRS), if the WTRU experiences frequency-flat or frequency-selective fading across different RBs belonging to the same RBG. The same approach may be adopted for a TDD-based DL transmission, where channel reciprocity may be leveraged to determine if the WTRU experiences frequency-flat or frequency-selective fading across the different RBs belonging to the same RBG.

For an FDD-based DL transmission, the WTRU may use a received reference signals such as a channel state information reference signal (CSI-RS) to determine if the WTRU experiences frequency-flat or frequency-selective fading across the different RBs belonging to a same RBG. If WTRU experiences the frequency-selective fading within the same RBG, the WTRU may report the measurements it has for channel variations across these RBs to the base station (e.g., a scheduler), so that the BS may allocate different video layers to different RBs accordingly.

The WTRU may be configured with a frequency allocation scheme for a video BL and a video EL in a frequency-selective manner or a frequency-flat manner, e.g., based on observed channel conditions, through dynamic signaling, or in a semi-static manner via RRC signaling. An activation or deactivation indication or command of the configured frequency allocation scheme (e.g., configured via RRC signaling) may be received via a MAC CE, DCI or SCI signaling.

The WTRU may receive one or more of the following parameters to determine the allocated frequency resources for a video layer: an activated BWP, a bitmap indicating allocated RBGs, or a variable indicating served video layers on a RBG (e.g., the variable may be a two-bits variable with which 00 may indicate a video BL, 01 may indicate a video EL, 10 may indicate a video BL and a video EL). For RBGs serving both a video BL and a video EL, if the WTRU receives the allocated frequency resources in a frequency-selective manner, the WTRU may receive a bitmap associated with each of the RBGs that may indicate the RBs carrying the video BL and/or the video EL (e.g., 1 for a video BL and 0 for a video EL). If the WTRU receives the allocated frequency resources in a frequency-flat manner, the WTRU may receive an indicator for the video layer carried over by other (e.g., early) RBs in the RBG and/or an indication of the number of RBs carrying the above-indicated video layer. The WTRU may receive the frequency-allocation related parameters described herein along with modulation related parameters, e.g., via a DCI message or RRC signaling.

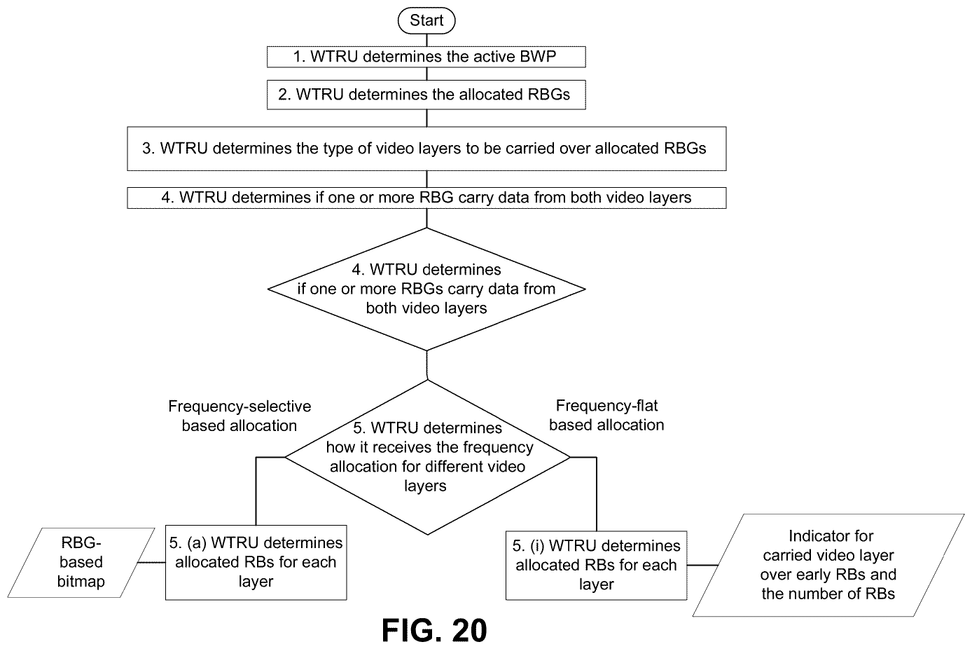

If the WTRU is configured with frequency allocation type 0, the WTRU may perform one or more of the following actions (e.g., to determine the frequency subcarrier(s) associated with a video layer's data symbols during UL and/or DL transmissions). FIG. 20 illustrates examples of such actions. As shown in FIG. 20, the WTRU may determine which BWP is activated from a set of RRC-configured BWPs based on a received indicator for the active BWP (e.g., via a DCI message or RRC signaling). The WTRU may determine the RBGs allocated for transmitting/receiving a PUSCH/PDSCH transmission based on a received bitmap indicating the allocated RBGs within the active BWP. The WTRU may determine the type of video layer(s) that may be carried in each RBG based on a received indicator. The WTRU may identify the RBG(s) carrying data associated with each video layer. The WTRU may check if a certain RBG carries both a video BL and a video EL. If the RBG carries both the video BL and the video EL, the WTRU may perform one or more of the following. The WTRU may determine how it may receive the allocated frequency resources for each video layer based on RRC signaling and/or whether an activation or deactivation indication or command is received via a MAC CE, DCI or SCI signaling. If WTRU receives the allocated frequency resources in a frequency-selective manner, the WTRU may receive a bitmap that may define the allocation of RBs between the different video layers within an RBG. If the WTRU receives the allocated frequency resources in a frequency-flat manner, the WTRU may receive an indication of the video layer that may be carried in other (e.g., early) RBs of the RBG and/or the number of RBs used to carry the video layer. The WTRU may identify the RBs carrying a current video layer and/or the RBs within the RBG that may carry the other video layer(s). The WTRU may determine the allocated frequency resources for receiving/transmitting the different video layers during a DL/UL transmission.

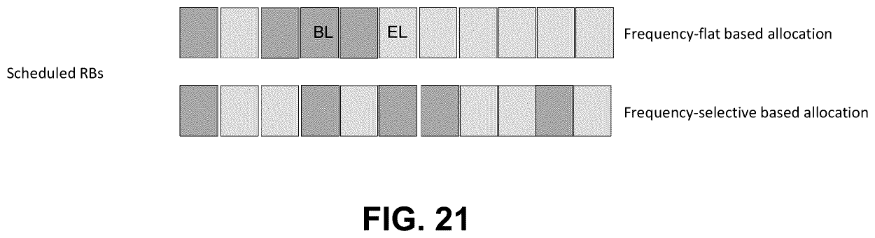

A video BL and a video EL may be mapped to different RBs. The WTRU may be configured with frequency allocation type 1, with which the WTRU may receive an RIV indicating the start RB and the number of contiguous scheduled RBs. The video BL and video EL may be assigned different RBs (e.g., as part of the RBs scheduled for the WTRU), as illustrated in FIG. 21.

For a TDD and/or FDD-based UL transmission, a base station may, based on a transmitted UL reference signal such as a sounding reference signal (SRS), determine if a WTRU experiences frequency-flat or frequency-selective fading across scheduled RBs. This approach may also be adopted for a TDD-based DL transmission, where channel reciprocity may be leveraged to determine if the WTRU experiences frequency-flat or frequency-selective fading across the scheduled RBs.

For an FDD-based DL transmission, the WTRU may a received reference signal such as a channel state information reference signal (CSI-RS) to determine if the WTRU experiences frequency-flat or frequency-selective fading across the different RBs belonging to a same RBG. If the WTRU experiences the frequency-selective fading across the different (e.g., adjacent) RBs, the WTRU may report the measurements it has for channel variations across the RBs to the base station (e.g., a scheduler) so that the base station may allocate different video layers to different RBs accordingly.

The WTRU may receive an indication of a configured frequency allocation scheme for a video BL and/or a video EL in a frequency-selective manner or a frequency-flat manner based on observed channel conditions (e.g., the indication may be received through dynamic signaling or in a semi-static manner in conjunction with RRC signaling). An activation or deactivation indication or command of the configured frequency allocation scheme (e.g., configured via RRC signaling) may be transmitted via a MAC CE, DCI or SCI signaling.

The WTRU may receive one or more of the following parameters that may be used to determine frequency resources allocated for a video layer: an activated BWP, the start RB of a set of serving RBs, or the length or number of the serving RBs. The WTRU may determine how it may receive the allocated frequency resources for the video layer and/or which RBs are carrying the video layer. If the WTRU receives the allocated frequency resources in a frequency-selective manner, the WTRU may receive a bitmap associated with a (e.g., each) RBG that may indicate the RBs in the RBG used to carry a video BL or a video EL (e.g., 1 may indicate a video BL and 0 may indicate a video EL). If the WTRU receives the allocated frequency resources in a frequency-flat manner, the WTRU may receive an indication of the video layer that may be carried in a set of RBs and/or the number of RBs that may carry the indicated video layer. The WTRU may receive the frequency-allocation related parameters described herein along with modulation related parameters, for example, via a DCI message or RRC signaling.

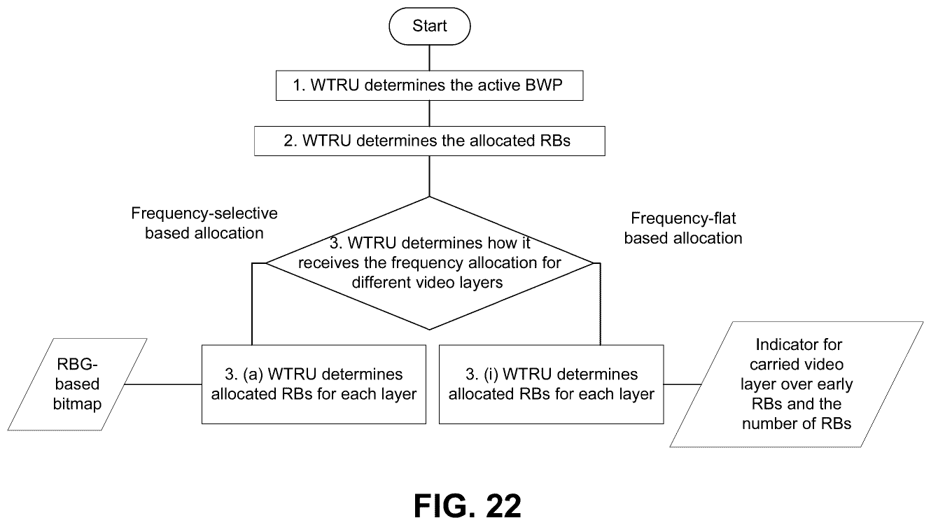

If the WTRU is configured with frequency allocation type 1, the WTRU may perform one or more of the following actions to determine the frequency subcarrier(s) that may carry a (e.g., each) video layer's data symbols during a UL or DL transmission. FIG. 22 illustrates examples of such actions. As shown, the WTRU may determine which BWP is activated from a set of RRC-configured BWPs based on a received indicator for the active BWP (e.g., via a DCI message or RRC signaling). The WTRU may identify a set of scheduled RBs for transmitting/receiving a PUSCH/PDSCH transmission based on a received RIV indicating the start RB and the number of contiguous scheduled RBs. The WTRU may identify how it may receive the allocated frequency resources for each video layer based on the RRC signaling and/or an activation or deactivation command received via a MAC CE, DCI or SCI signaling (e.g., the WTRU may determine which RBs carry a video BL and which RBs carry a video EL). If the WTRU receives the allocated frequency resources in a frequency-selective manner, the WTRU may determine the type of video layer(s) carried in each RB based on a received bitmap indicating the type of video layer carried in each RB. The WTRU may identify the RB(s) that may carry each video layer's data. If the WTRU receives the allocated frequency resources in a frequency-flat manner, the WTRU may determine the type of video layer(s) carried over other (e.g., early) scheduled RBs based on a received indicator for the video layer carried over the other (e.g., early) RBs. The WTRU may determine the RBs carrying an identified video layer based on the received number of RBs that may carry this video layer. The WTRU may determine the RBs carrying other video layers. The WTRU may determine allocated frequency resources for receiving/transmitting different video layers during a DL/UL transmission.

For an UL transmission under frequency allocation type 2, a video BL and a video EL may be allocated to different RBs. Under such a frequency allocation, the WTRU may transmit UL data over one or more consecutive RB interlaces. The video BL and video EL may be transmitted over different RBs within a same RB interlace or over different interlaces. The WTRU may receive one or more of the following parameters that may be used to identify which RBs are used to carry a video layer: an activated BWP, a bitmap indicating RB interlaces allocated to the WTRU (e.g., for numerology type 1), or an RIV indicating the start interlace and the number of contiguous interlace indices (e.g., for numerology type 0). The WTRU may receive a variable that may indicate the video layer(s) carried in each allocated RB interlace. The variable may be a two-bits variable (e.g., 00 may indicate a video BL, 01 may indicate a video EL, and 10 may indicate a video BL and a video EL). For RB interlaces carrying both a video BL and a video EL, a bitmap may be provided to indicate the allocation of RBs to the different video layers.

For a UL transmission, the WTRU may determine (e.g., after the WTRU determines the activated BWP as discussed herein) which RB interlaces are allocated for the UL transmission based on a received bitmap or an RIV described herein. The WTRU may identify which interlaces are allocated to the video BL and which interlaces are allocated to the video EL(s). For interlaces that carry both a video BL and a video EL, the WTRU may use a received bitmap to determine which RBs in this RB interlace carry the video BL and which RBs in the RB interlace carry the video EL.

Video layer specific time resource allocation and signaling may be implemented. For example, a WTRU may receive an index pointing to a certain row in a configured table (e.g., one of multiple configured tables) and may use the index to determine the time resources scheduled for the WTRU (e.g., which symbols may be used to receive/transmit DL/UL data). Using the index, the WTRU may, after reception of a scheduling DCI, determine a time slot for data reception/transmission (e.g., k_0 for PDSCH reception, k_1 for ACK/NACK transmission, and k_2 for PUSCH transmission). The WTRU may determine a PDSCH/PUSCH mapping type that may indicate where DMRS may be transmitted within an allocated slot or symbol for a transmission. The WTRU may determine the start symbol(S) and/or the length (L) of assigned symbols (SLIV) within the slot for the PDSCH or PUSCH transmission.

The WTRU may receive information about time resources (e.g., symbols) allocated for a video layer (e.g., in addition to time resource related parameters determined by the WTRU such as the starting symbol S and length L described above). For example, the WTRU may receive a configured time allocation scheme for a video BL and a video EL via dynamic signaling or in a semi-static manner via RRC signaling. The configured time allocation scheme may be in a consecutive or non-consecutive manner based on a reported Doppler shift from the WTRU to the network (e.g., to a base station). An activation or deactivation indication or command of the configured frequency allocation scheme (e.g., configured via RRC signaling) may be transmitted via a MAC CE, DCI or SCI signaling. For instance, for slow-varying channel conditions, the WTRU may receive a consecutive allocation for a video layer. For fast-varying channels, the WTRU may receive a non-consecutive allocation for a video layer. For example, time symbols with favorable channel conditions (e.g., time symbols closer to the symbols carrying DMRS signals) may be assigned to a video BL.

The WTRU may receive one or more of the following parameters, which may be used to identify the assigned time symbols for a video layer. The WTRU may receive an indicator regarding whether data from the same video layer is carried over consecutive or non-consecutive symbols. If a consecutive allocation is configured for the same video layer data, the WTRU may receive an indication for the video layer carried in early time symbols (e.g., 1 may indicate a video B and 0 may indicate a video EL) and/or a length or number of the allocated symbols for the indicated video layer (e.g., L_1). If a non-consecutive allocation of time symbols is configured for the same video layer data, the WTRU may receive a bitmap indicating the allocated symbols for a video BL and a video EL (e.g., 1 may indicate a video BL and 0 may indicate a video EL). The WTRU may receive the time-allocation related parameters along with modulation and/or frequency allocation related parameters via a DCI message or RRC signaling.

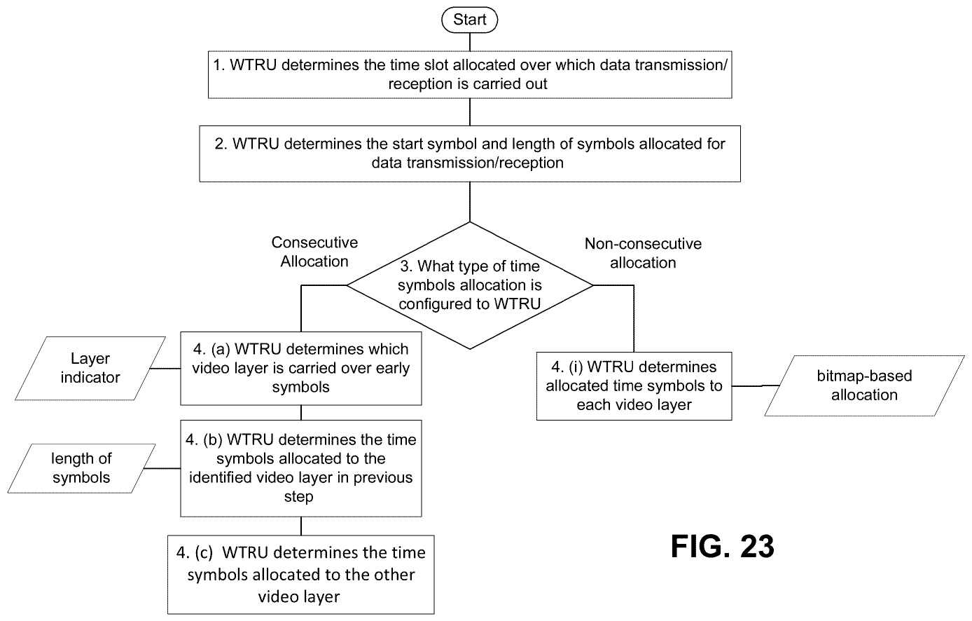

FIG. 23 illustrates examples of actions that may be performed by a WTRU to determine the time symbols used to carry a video layer's data during a UL or DL transmission. As shown in FIG. 23, the WTRU may determine the time slot(s) over which a data transmission/reception may be performed based on a received index indicating one or more time allocation parameters. The WTRU may determine the start symbol(S) and/or length (L) of the allocated symbols within the allocated time slot(s) based on the received index indicating the time allocation parameters. The WTRU may determine the way a video layer's symbols are allocated over the time symbols based on a received indicator identifying an allocation type. The WTRU may determine the time symbols carrying a video layer's data symbols. The WTRU may determine how it may receive the allocated time symbols for a video layer based on RRC signaling and/or an activation or deactivation command is received via a MAC CE, DCI or SCI signaling. If the WTRU receives the allocated time resources in a consecutive allocation manner, the WTRU may determine which video layer is allocated to early symbols within the allocated time symbols based on a received indicator associated with the video layer. The WTRU may then determine the specific time symbols that may carry the data of the video layer (e.g., S→S+L₁) based on a received length of the video layer allocated to the early symbols. The WTRU may also determine the time symbols that may carry the data associated with another video layer (e.g., as S+L₁+1→S+L). If the WTRU receives the allocated time resources in a non-consecutive allocation manner, the WTRU may determine the carrying symbols for a video layer's data based on a received bitmap indicating the allocation of scheduled time symbols for video layers.

A UEP scheme may be dynamically adapted. Different flows or video layers may be given different treatment (e.g., based on the priority of each flow or video layer) in a protocol stack layer (e.g., the PHY layer). This may be accomplished, for example, through unequal error protection over active modulation constellations. The unequal error protection may be dynamically adapted, for example, as a function of the inherent priority of data content (e.g., video layers), device capabilities, and/or system aspects including scheduling decisions, available capacities, system load, changing radio conditions, etc.

Measurement quantities may be defined and used to adapt UEP schemes dynamically. Channel time variation may be estimated and reported (e.g., as a feedback). A measurement of how fast channel conditions are changing with time may be used to facilitate the dynamic adaptation of UEP schemes. The measurement quantities may include a rate of change based on the phase of an estimated channel or the channel magnitude (e.g., ignoring the phase). This measurement may be made more precise in the form of a Doppler estimate among available channel estimates at different time instants. Additional conditions in terms of averaging and/or filtering may be defined to stabilize this measurement prior to the feedback and used in the dynamic adaptation.

In at least the downlink (DL) direction, a WTRU may estimate the rate of change of channel conditions through estimates made over one or a combination of existing reference signals (RSs). These RSs may include a DMRS associated with an SSB, a DMRS associated with data, a CSI-RS, and/or an SSB. Additional RSs may be defined for this purpose. These RS may be WTRU dedicated, group common, or cell/beam specific, which may allow the WTRU to perform a Doppler estimate.

In response to obtaining a measurement of the channel time variation, the WTRU may feedback the measurement to the network (e.g., a base station) so that the measurement may be used (e.g., by the network) for the dynamic adaptation of UEP schemes in combination with other parameters/constraints. An indication of the channel time variation may be transmitted in the form of a flag (e.g., a single bit), which may indicate that the channel time variation may be larger than a pre-defined or configured threshold.

The network (e.g., a base station) may configure the size and/or pattern of the channel time variation feedback. A set of options may be indicated to the WTRU, for example, as a part of semi-static configuration. An indication of an estimated channel time variation may be provided, e.g., after suitable processing/filtering, as feedback to the network (e.g., as a part of uplink control information (UCI)). The UCI carrying the channel time variation indication may be transmitted in the PUCCH or in the PUSCH. The channel time variation feedback may be configured as periodic, semi-static, or aperiodic. The network may configure parameters that may control the periodicity and/or other characteristics of the feedback.

Channel frequency selectivity may be estimation and/or reported (e.g., as a feedback). Channel variation in the frequency domain or channel frequency selectivity may be used to choose a UEP scheme, for example, to combat frequency selectivity and prevent deep fades from hitting prioritized video layers or other types of data. The measurement quantity associated with channel frequency selectivity may include a rate of change based on the phase of an estimated channel or based on a channel magnitude (e.g., ignoring the phase). Additional conditions in terms of averaging and/or filtering may be defined to stabilize this measurement quantity prior to its feedback and used in the dynamic adaptation of UEP schemes.

In at least the downlink (DL) direction, a WTRU may estimate the channel frequency selectivity through multiple channel estimates made over different parts of the bandwidth. These estimates may be made using a suitable RS or a combination of RSs. These RSs may include DMRS of an SSB, DMRS of data, CSI-RS, or SSBs. Additional RSs may be defined for this purpose. These RSs may be WTRU dedicated, group common or cell/beam specific, which may allow the WTRU to estimate a channel over different frequency portions. Both DMRS type 1 and type 2 may be used to estimate the channel frequency selectivity (e.g., as they may span all the PRBs in the scheduled resources). Existing CSI-RS patterns may be used to estimate the channel frequency selectivity.

In response to obtaining a measurement of the channel frequency selectivity, the WTRU may report (e.g., as feedback) the measurement to the network so that the measurement may be used by the network for dynamic adaptation of UEP schemes (e.g., in combination with other parameters/constraints). Rules on how to perform averaging, filtering, or other aspects of the adaptation (e.g., such as the minimum number of measurements to be averaged prior to feeding back the measurement quantity to the network) may be established.

An indication of the channel frequency selectivity may be transmitted in various forms such as a flag (e.g., a single bit flag), which may indicate that the channel frequency selectivity is larger than a pre-defined or configured threshold. The network may configure the size, pattern and/or other characteristics of the channel frequency selectivity feedback. A set of options may be indicated to the WTRU, for example, as a part of semi-static configuration. The channel frequency selectivity indication may be provided (e.g., after suitable processing and/or filtering) as feedback to the network, such as, e.g., as a part of uplink control information (UCI). The UCI carrying the channel frequency selectivity indication may be transmitted in the PUCCH or in the PUSCH. The channel frequency selectivity feedback may be configured as periodic, semi-static or aperiodic. The network may configure suitable parameters for controlling the periodicity and/or other characteristics of this feedback.

The WTRU may provide a report, request, or feedback regarding one or more target UEP parameters. For example, the WTRU may make a request (e.g., a direct request) to the network for modulation (e.g., constellation) and/or video layer mapping related parameters that the WTRU may wish to use. The request (e.g., which may also be referred to as a report or feedback) may be made to a base station, for example, via an indication in the UCI. The parameters indicated by the request may include desired or expected reception parameters with which the WTRU may receive a layered video in the DL. The parameters indicated by the request may include desired or expected parameters with which the WTRU may transmit a layered video to the base station in the uplink direction. The parameters may include modulation related UEP parameters such as constellation design parameters (e.g., distance parameters), a bit allocation for various video layers, a relative mapping for video layers, etc. For separate constellation based UEP schemes, the parameters may include requested constellation per video layer, constellation and/or video layer based mapping in the frequency or time domain, etc.

The feedback (e.g., direct feedback) associated with the requested or target UEP parameters (e.g., modulation related parameters) may be transmitted as a part of uplink control information. The feedback may be transmitted via (e.g., as a part of) the PUCCH or PUSCH. The base station may configure the feedback, for example, as periodic, semi-static or aperiodic reports. The feedback (or reporting) may be event-triggered (e.g., to cover dynamic variations), where suitable triggers may be defined for the feedback or reporting. An example of a suitable trigger may be defined in terms of channel variations in time or frequency being more than a configured threshold. In response to receiving the feedback regarding (e.g., request for) UEP parameters (e.g., modulation based UEP parameters), the base station may use the feedback, other reporting by the WTRU (e.g., radio measurement reports) and/or other system considerations to adapt the UEP parameters for subsequent transmissions.

Different modulation parameters (e.g., constellation sets) may be assigned to different video layers having different priorities (e.g., in the separate constellation use case). The nature of traffic flows (e.g., video layers), system design considerations, WTRU capabilities, and/or long-term channel characteristics for the WTRU may be used to assign different resource or different priorities to different video layers (e.g., in a UEP scheme).

A UEP scheme may allow dynamic adjustments in the face of network dynamics (e.g., to make use of available resources for multi-layer video transmission). Such dynamic adjustments may include variations in the system load, different cell capacities while the WTRU is in a mobility state and under changing radio conditions, and/or the like. The WTRU may estimate and report different measurement quantities to the network in suitable formats to indicate current channel conditions.

A determination of which time and frequency resources may be allocated to which modulated data (e.g., video layers modulated with different selected constellation sets) may be made (e.g., by a WTRU). In addition to the time and frequency resource allocation, the determination may further include which interleaving may be selected over suitable subsets of allocated resources for a given constellation or video layer. The knowledge of channel selectivity in time and/or frequency may be used to facilitate the selection. The network may determine suitable channel resource (e.g., with less time variation, out of fade, less frequency selectivity, etc.) within scheduled resources for a prioritized video base layer and its associated modulation parameters (e.g., constellation parameters). This may lead to a higher probability of successful detection for the video base layer. In addition to the resource allocation/assignment, the network may also adapt rates for the video base layer and subsequent video enhancement layer(s) or the number of enhancement layers as parts of the dynamic adaptation.

If channel frequency variations are known at the base station (e.g., because of channel reciprocity or feedback from the WTRU), the base station may allocate suitable frequency resources (e.g., PRBs, or groups of PRBs) for different video layers (e.g., a base layer and one or more enhancement layers) and/or suitable modulation parameters (e.g., constellations or MCS) for the video layers. The network may use a time variation indication to adjust the rates for the video base layer and the one or more video enhancement layers. The transmission parameters of the video (e.g., an updated dynamic split of bits assignment), the transmission of a given number of video layers, and/or the relevant time-frequency resource allocation/split among different video layers may be indicated to the WTRU (e.g., through dynamic signaling such as DCI).

Parameters associated with separate modulations (e.g., constellations) may be dynamically updated. A transmitting device such as a WTRU may make dynamic updates to the transmission parameters associated with a layered video. The transmitting device may map (e.g., allocate or link) different video layers to different modulation parameters (e.g., constellation bits) and may set the size of a video layer for a given set of modulation parameters (e.g., a given constellation). Modulation parameters such as constellation design parameters may be updated to obtain a more suitable form of modulation (e.g., constellation) in view of system considerations, WTRU capabilities, feedback from a receiver about channel variations, etc. The constellation design parameters (e.g., d1, d2 and d3) may be updated with respect to available information elements. The update of constellation design parameters may result in a change in the expected probability of detection for various video layers. Such a change may achieve a given prioritization of different video layers.

A device such as a WTRU may switch from using single-root constellation to using multi-root constellation, or update one multi-root constellation to another multi-root constellation of different parameters. The mapping of different video layers to corresponding constellations may be updated. For example, the mapping of a given video enhancement layer may be updated as a function of detected bits (e.g., sub-symbols) corresponding to a video base layer.

Switching of UEP schemes may be accomplished with or without feedback from a WTRU. For modulation based UEP schemes, a first set of schemes may build a hierarchical modulation constellation for transmission/reception of a layered video, and a second set of schemes may be based on video layer specific modulation constellations. A base station may provide the relevant configurations for the hierarchical constellation and the separate video layer specific constellation, while also providing an indication of which configuration(s) is active. The active configuration(s) may then be used for UL or DL transmission of layered video data. The base station may switch the active configuration(s), for example, based on changing requirements, channel conditions, and/or system considerations. Signaling associated with switching the active configuration(s) may be transmitted through semi-static signaling or in a more dynamic manner (e.g., by indicating the switch in DCI). This may be achieved, for example, by a flag (e.g., a single bit flag) that may provide the active configuration indication.

A WTRU may request the base station to switch the active configuration(s) for a layered video transmission/reception. Such a configuration switch request may be transmitted to the base station in the uplink direction, e.g., by adding the active configuration switch indication in a UEP related feedback.

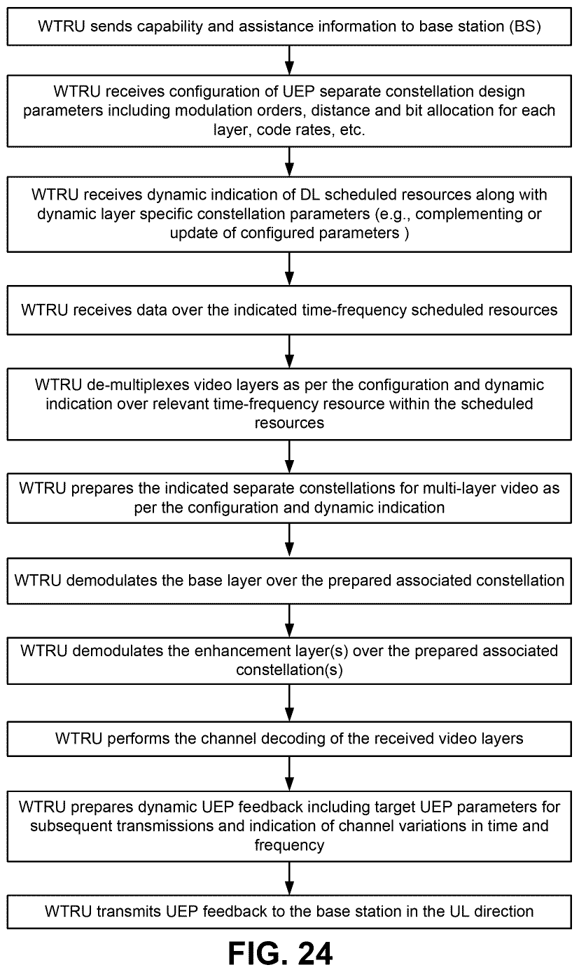

FIG. 24 illustrates an example of a layered video transmission in the DL direction based on separate constellation based UEP. In this example, a WTRU may report its capability and/or provide assistance information (e.g., regarding the WTRU's video processing capabilities and/or desired modulation parameters) to a network device such as a base station (BS). In response, the BS may provide a separate constellation based UEP configuration for layered video transmission. This configuration may include parameters of video layer specific constellations, a distance, a bit mapping, etc. The configuration may indicate that dynamic update may be performed for a subset of the parameters. In examples, the configuration may provide a set of parameters that may be completed by a dynamic indication later. In examples, the configuration may provide a set of parameters related to the choice of active constellations and/or the construction of a constellation with suitable parameters. Some of the parameters configured by the base station may be overwritten later by a dynamic indication. The overwriting of UEP parameters as part of the dynamic indication may provide the network with the ability to respond to dynamic traffic changes and/or network system load variations, and to adapt the UEP schemes to the channel variations. A scheduling DCI may provide the time and/or frequency resources for a layered video transmission. The scheduling DCI may include additional information regarding layer based modulation parameters (e.g., separate constellations for separate video layers). Upon decoding the DCI, the WTRU may receive the scheduled data (e.g., video layers) and may demultiplex different video layers based on the configuration and/or indications included in the DCI. The WTRU may prepare the constellations for the received layers based on the received information from the BS. The WTRU may demodulate a video base layer and a video enhancement layer using the prepared constellations. After the demodulation, the WTRU may proceed to the channel decoding of the demodulated video layers. The WTRU may prepare a UEP related feedback, which may include a request for a specific set of target constellations from the BS for the next transmission. The WTRU may transmit the UEP feedback in the UL direction. The BS may update the layered video transmission parameters and/or constellations for a subsequent transmission based on the UEP feedback (e.g., dynamic UEP feedback) from the WTRU.

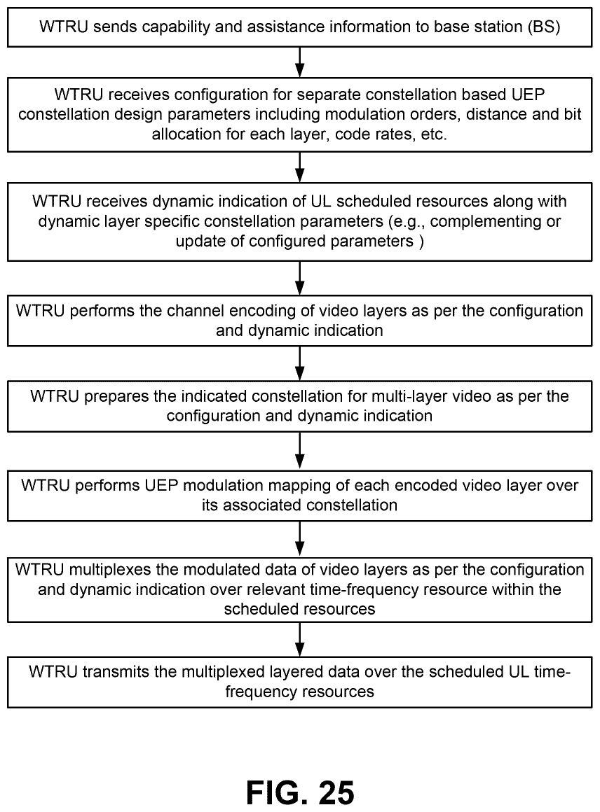

FIG. 25 illustrates an example of a separate constellation based UEP layered video transmission in the UL direction. In this example, a WTRU may report its capabilities and/or provide assistance information (e.g., regarding the WTRU's video processing capabilities and/or desired modulation parameters) to a base station (BS). In response, the BS may provide a separate constellation based UEP configuration for layered video transmission in the UL direction. This configuration may provide parameters such as video layer specific constellations, a distance, a bit mapping, etc. The configuration may indicate that the parameters may be dynamically updated (e.g., via a DCI). A scheduling DCI may be transmitted to the WTRU to provide time and/or frequency resources for an UL transmission. The scheduling DCI may include additional information regarding modulation parameters such as separate constellation information. In examples, the configuration from the base station may provide a set of parameters that may be completed (e.g., activated) by a dynamic indication in DCI. For example, the configuration (e.g., RRC configuration) may provide a set of parameters related to the choice of active constellations and/or the construction of a constellation with suitable parameters, and some of these parameters may be overwritten later by an DCI based indication. The overwriting of UEP parameters as part of a dynamic indication may provide the network with the ability to respond to dynamic traffic changes and/or network system load variations, and to adapt the UEP schemes to channel variations. Upon decoding the DCI, the WTRU may perform channel encoding of different layers of a video (e.g., if the WTRU is to make a layered video transmission). The WTRU may determine a set of modulation parameters (e.g., modulation orders, coding rates, constellations, etc.) for the video layers to be transmitted, where the modulation parameters (e.g., modulation orders, coding rates, or constellation parameters) for each layer may be determined by the WTRU based on the parameters received from the RRC configuration and/or a DCI based dynamic indication (e.g., information included in a scheduling DCI). The WTRU may modulate each encoded video layer based on the determined modulation parameters (e.g., modulation orders, coding rates, constellations, etc.) determined for the video layer. The WTRU may perform multiplexing of the modulated video layers over all or a subset of the time frequency resources allocated by the scheduling DCI. For example, the WTRU may determine that a first subset of the received grant is to be used to transmit a base layer of video data and that a second subset of the received grant is to be used to transmit an enhancement layer of video data. The multiplexing may be performed based on a resource element level granularity, a resource block level granularity, or a resource block group level granularity split, e.g., as indicated by the received configuration or DCI. The WTRU may transmit the multiplexed layered video data using the UL time frequency resources determined for the video layers. The BS may update the layered video transmission parameters for a subsequent WTRU transmission based on channel estimates and other system/scheduler considerations.

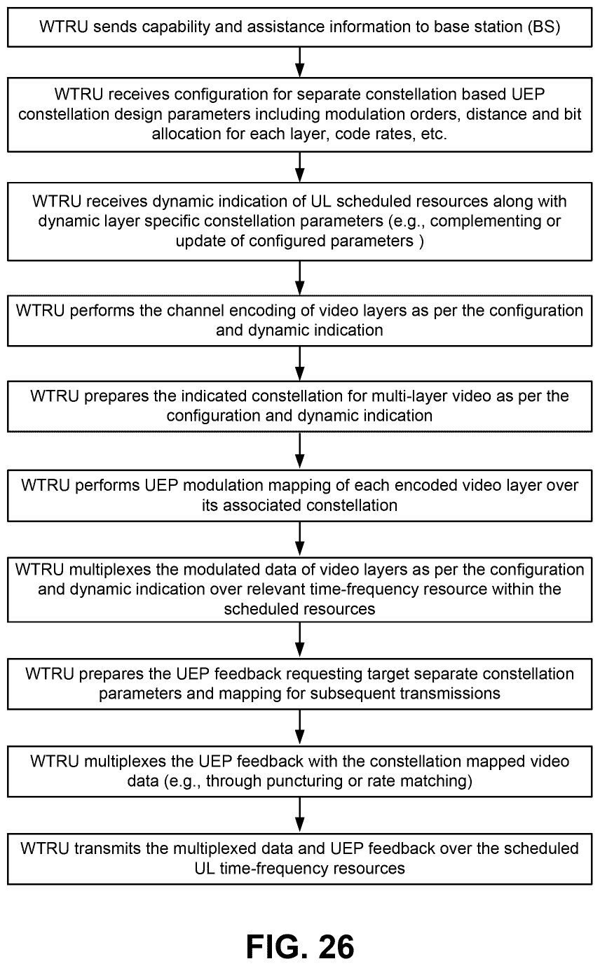

FIG. 26 illustrates an example of a separate constellation based UEP layered video transmission in the UL direction with a WTRU providing UEP relevant feedback to a base station. In this example, the WTRU may report its capabilities and/or provide assistance information (e.g., regarding the WTRU's video processing capabilities and/or desired modulation parameters) to the base station (BS). In response, the BS may provide a separate constellation based UEP configuration for layered video transmission in the UL direction. This configuration may include parameters such as video layer specific constellations, a distance, a bit mapping, etc. The configuration may indicate that the parameters may be dynamically updated. A scheduling DCI may be transmitted to provide UL time frequency resources and/or additional modulation related information (e.g., separate constellation related information). Upon decoding the DCI, the WTRU may perform channel encoding of different video layers (e.g., if the WTRU is to perform a layered video transmission). The WTRU may determine, based on the configuration and/or DCI, modulation parameters (e.g., modulation orders, coding rates, constellations, etc.) for the video layers to be transmitted. The WTRU may modulate each encoded video layer based on the determined parameters (e.g., based on the modulation order, coding rate, and constellation for each video layer). The WTRU may perform multiplexing of the modulated video layers over all or a subset of the time frequency resources indicated by the DCI. For example, the WTRU may determine that a first subset of the received grant is to be used to transmit a base layer of video data and that a second subset of the received grant is to be used to transmit an enhancement layer of video data. The multiplexing may be performed based on a resource element level granularity, a resource block level granularity, or a resource block group level granularity split, e.g., as indicated by the received configuration or DCI. The WTRU may prepare UEP related feedback, which may include a target set of modulation parameters (e.g., constellations) for a subsequent transmission to be performed with video layer specific mapping and differentiated modulation parameters (e.g., constellation design parameters). For example, the feedback may indicate target constellation sets with additional design parameters such as a relative distance for one or more (e.g., each) of the indicated constellations. The WTRU may multiplex the UEP feedback with the layered video data. The WTRU may transmit the multiplexed UEP feedback and the layered video data over the scheduled UL time frequency resources. In response to the feedback, the BS may update the layered video transmission parameters for a subsequent UEP transmission based on channel estimates and/or other system/scheduler considerations.

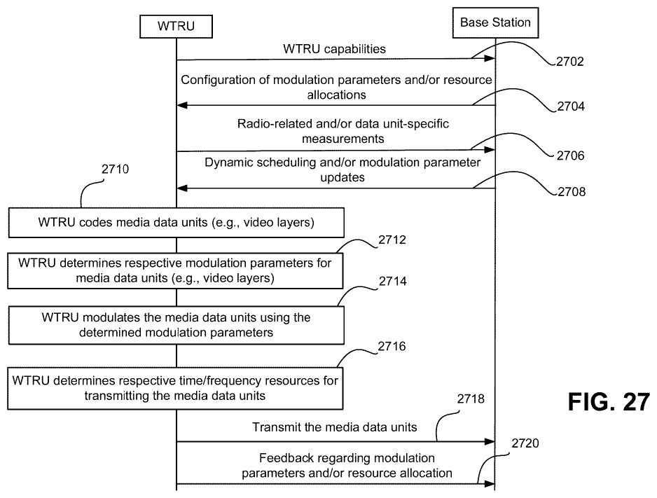

FIG. 27 illustrates examples operations and messages that may be associated with differentiated modulations or resource allocations of media data units (e.g., such as video layers). As shown in FIG. 27, a WTRU may report its capabilities (e.g., in one or more RRC messages or via UCI) to a base station at 2702. As described herein, the reported capabilities may indicate the WTRU's ability to differentiate between media data units that may be associated with the same QoS flow. The capabilities may also indicate the WTRU's ability to treat different video layers associated with the same QoS flow differently. The capabilities may also indicate the WTRU's ability to use different modulation parameters (e.g., constellation diagrams) to modulate different video layers (e.g., simultaneously). At 2704 of FIG. 27, the WTRU may receive configuration information (e.g., via RRC signaling) from the base station that may indicate modulation parameters and/or resource allocations for media data units (e.g., video layers). The configuration information may, for example, indicate modulation schemes for the media data units, an indication of a reference media data unit (e.g., a reference video layer), modulation parameters for the media data units, and/or resource allocations for the media data units. At 2706, the WTRU may perform and/or report various measurements that may include one or more of the RSSI, RSRP, RSRQ, SINR, CSI, BSR, channel time variation indicator, or channel frequency selectivity indicator described herein. The measurements may be performed and/or reported at a media data unit level (e.g., for each video layer).

At 2708, the WTUR may receive dynamic scheduling information from the base station, which may indicate a grant for the WTRU to perform uplink transmissions, a HARQ RV, a MCS, and/or modulation parameter updates for the WTRU to use with the grant. As described herein, the grant may include time and frequency resources (e.g., frequency allocation type, active BWP, allocated RBGs or RBs, slots, symbols, SLIV, resource partitioning, etc.), and the modulation parameters may include modulation orders, coding rates, constellation parameters, etc. that may be associated with different modulation schemes. Also as described herein, the information received by the WTRU at 2708 may be conveyed via a DCI message such a scheduling DCI message.

At 2710, the WTRU may code bitstreams associated with the media data units (e.g., video layers) that the WTRU has to transmit. At 2712, the WTRU may determine respective modulation parameters for the media data units (e.g., video layers) that the WTRU has to transmit based on the information received at 2708. For example, the WTRU may map a first set of modulation parameters (e.g., first constellation sets) to a first media data unit (e.g., a base layer of video data) and a second set of modulation parameters (e.g., second constellation sets) to a second media data unit (e.g., an enhancement layer of video data). The WTRU may then modulate the media data units at 2714 using the determined modulation parameters (e.g., the WTRU may modulate bitstreams associated with the video layers using the constellation sets determined at 2412).

At 2716, the WTRU may further determine respective time/frequency resources for transmitting the media data units. For example, the WTRU may determine that a first subset of the grant received at 2708 is to be used to transmit the modulated data of the first media data unit (e.g., the base layer of video data) and that a second subset of the grant is to be used to transmit the modulated data of the second media data unit (e.g., the enhancement layer of video data). The WTRU may map allocated RBGs or RBs to the media data unit. The WTRU may also map subcarriers within one or more RBs to the media data units. The WTRU may also map allocated time symbols to the media data units. The WTRU may then transmit the modulate data associated with the media data units using the determined resources at 2718 (e.g., the WTRU may multiplex the media data units over the determined resources). At 2720, the WTRU may prepare and transmit feedback regarding modulation schemes and/or resource allocations for the media data units to the base station. For example, the WTRU may indicate in the feedback target modulation parameters (e.g., constellation sets) for subsequent media data transmissions. The WTRU may transmit the feedback to the base station separately or multiplex the feedback with the media data, and the base station may use the feedback (e.g., in addition to channel estimates and/or other system considerations) to determine modulation parameters and/or resources for future transmissions of the WTRU.

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

1. A wireless transmit/receive unit (WTRU), comprising:
a processor configured to:
receive a message from a network device associated with a wireless communication network, wherein the message indicates at least an uplink grant comprising time and frequency resources for performing an uplink transmission via the wireless communication network, the message further indicating a first set of modulation parameters and a second set of modulation parameters;
determine that a first media data unit and a second media data unit are to be transmitted to the network device; and
based on a further determination that the first media data unit differs from the second media data unit with respect to at least a transmission priority:
modulate the first media data unit using the first set of modulation parameters;
modulate the second media data unit using the second set of modulation parameters; and
transmit the first modulated media data unit and the second modulated media data unit to the network device via the wireless communication network, wherein the first modulated media data unit is transmitted using a first subset of the time and frequency resources of the uplink grant, and wherein the second modulated media data unit is transmitted using a second subset of the time and frequency resources of the uplink grant.

2. The WTRU of claim 1, wherein the first media data unit comprises a base layer of video data, wherein the second media data unit comprises an enhancement layer of video data, and wherein the base layer is associated with a higher transmission priority than the enhancement layer.

3. The WTRU of claim 2, wherein the base layer of video data and the enhancement layer of video data are associated with the same video content, and wherein, when processed together with the base layer of video data, the enhancement layer of video data improves the quality of the video content.

4. The WTRU of claim 2, wherein the processor is further configured to determine a target set of modulation parameters associated with the base layer of video data or the enhancement layer of video data, and transmit a report indicative of the target set of modulation parameters to the network device.

5. The WTRU of claim 4, wherein the message that indicates the uplink grant, the first set of modulation parameters, and the second set of modulation parameters is received from the network device in response to the transmission of the report.

6. The WTRU of claim 1, wherein the message received from the network device indicates respective subsets of time and frequency resources to be used for the first media data unit and the second media data unit.

7. The WTRU of claim 1, wherein the first set of modulation parameters includes one or more of a first modulation order or a first coding rate, and wherein the second set of modulation parameters includes one or more of a second modulation order or a second coding rate.

8. The WTRU of claim 1, wherein the processor being configured to modulate the first media data unit using the first set of modulation parameters and the second media data unit using the second set of modulation parameters comprises the processor being configured to map, autonomously, the first set of modulation parameters to the first media data unit and the second set of modulation parameters to the second media data unit.

9. The WTRU of claim 1, wherein the message received from the network device indicates that the first set of modulation parameters is to be used for the first media data unit and that the second set of modulation parameters is to be used for the second media data unit.

10. The WTRU of claim 1, wherein the processor being configured to transmit the first modulated media data unit and the second modulated media data unit to the network device comprises the processor being configured to multiplex the first modulated media data unit and the second modulated media data unit.

11. A method implemented by a wireless transmit/receive unit (WTRU), the method comprising:
receiving a message from a network device associated with a wireless communication network, wherein the message indicates an uplink grant comprising time and frequency resources for performing an uplink transmission via the wireless communication network, the message further indicating a first set of modulation parameters and a second set of modulation parameters;
determining that a first media data unit and a second media data unit are to be transmitted to the network device; and
in response to further determining that the first media data unit differs from the second media data unit with respect to at least a transmission priority:
modulating the first media data unit using the first set of modulation parameters;
modulating the second media data unit using the second set of modulation parameters; and
transmitting the first modulated media data unit and the second modulated media data unit to the network device via the wireless communication network, wherein the first modulated media data unit is transmitted using a first subset of the time and frequency resources of the uplink grant, and wherein the second modulated media data unit is transmitted using a second subset of the time and frequency resources of the uplink grant.

12. The method of claim 11, wherein the first media data unit comprises a base layer of video data, wherein the second media data unit comprises an enhancement layer of the video data, and wherein the base layer is associated with a higher transmission priority than the enhancement layer.

13. The method of claim 12, wherein the base layer of video data and the enhancement layer of video data are associated with the same video content, and wherein, when processed together with the base layer of video data, the enhancement layer of video data improves the quality of the video content.

14. The method of claim 11, further comprising determining a target set of modulation parameters associated with the base layer of video data or the enhancement layer of video data, and transmitting a report indicative of the target set of modulation parameters to the network device.

15. The method of claim 14, wherein the message that indicates the uplink grant, the first set of modulation parameters, and the second set of modulation parameters is received from the network device in response to the transmission of the report.

16. The method of claim 11, wherein the message received from the network device indicates respective subsets of time and frequency resources to be used for the first media data unit and the second media data unit.

17. The method of claim 11, wherein the first set of modulation parameters includes one or more of a first modulation order or a first coding rate, and wherein the second set of modulation parameters includes one or more of a second modulation order or a second coding rate.

18. The method of claim 11, wherein modulating the first media data unit using the first set of modulation parameters and the second media data unit using the second set of modulation parameters comprises mapping, autonomously, the first set of modulation parameters to the first media data unit and the second set of modulation parameters to the second media data unit.

19. The method of claim 11, wherein the message received from the network device indicates that the first set of modulation parameters is to be used for the first media data unit and that the second set of modulation parameters is to be used for the second media data unit.

20. The method of claim 11, wherein transmitting the first modulated media data unit and the second modulated media data unit to the network device comprises multiplexing the first modulated media data unit and the second modulated media data unit.
